(19) United States
(12) Patent Application Publication
(10) Pub. No.: US 2026/0029097 A1
(43) Pub. Date: Jan. 29, 2026

(54) LIGHT GUIDE AND LIGHT GUIDE ASSEMBLY

(71) Applicant: HONDA MOTOR CO.,LTD., Tokyo (JP)

(72) Inventor: Takeomi OKIMITSU, Saitama (JP)

(21) Appl. No.: 19/346,595

(22) Filed: Oct. 1, 2025

Related U.S. Application Data
(63) Continuation of application No. PCT/JP2024/023131, filed on Jun. 26, 2024.

(30) Foreign Application Priority Data
Jun. 30, 2023 (JP) 2023-108184
Dec. 28, 2023 (JP) 2023-222936

(51) Int. Cl. F21S 11/00; F21V 8/00

(52) U.S. Cl. CPC F21S 11/002; G02B 6/0035; G02B 6/0076

(57) ABSTRACT

A light guide includes: a light entrance section which has a light entrance surface to which light is input, reflective surfaces and a light transmitting section, the reflective surfaces reflecting a part of the light input, and the light transmitting section transmitting another part of the light input and reflected light reflected by the reflective surfaces; a light guiding section which has a light exit surface, and guides the reflected light so that it is output from the light exit surface; and a continuous section and a non-continuous section. A large part of the light collected by the light entrance section can be output from the light exit surface, by a part of the light input being reflected by the reflective surfaces and the reflected light entering the light guiding section from the light transmitting section via the continuous section to be guided within the light guiding section.

The contents of the following patent application(s) are incorporated herein by reference:
NO. 2023-108184 filed in JP on Jun. 30, 2023
NO. 2023-222936 filed in JP on Dec. 28, 2023
NO. PCT/JP2024/023131 filed in WO on Jun. 26, 2024.

### BACKGROUND

### 1. Technical Field

The present invention relates to a light guide and a light guide assembly.

### 2. Related Art

In order to suppress an emission amount of carbon dioxide, utilization of regenerative energy such as photovoltaics has been accelerated. However, conversion efficiency from light to electricity may not be high. In this regard, there has been developed a sunlight illumination system designed for efficient utilization of sunlight by collecting and guiding the sunlight to another location to be used for illumination without being converted into electricity. For example, Patent Document 1 discloses a light capturing device including a light guiding section extending in parallel from a plane of incidence in which light is input and a plurality of light collecting elements which are connected with the light guiding section to gradually narrow and each of which has a light collecting section where a reflective surface is provided on an end, a plurality of coupled waveguides which guide the light entering from the plurality of light collecting elements via each reflective surface, and an integrated waveguide which is connected with the plurality of coupled waveguides and which collects the light. The light collecting element in such a light capturing device may not have high light collecting efficiency because, while it collects plenty of light, it leaks the collected light from the light collecting element if the light reverses.
Patent Document 1: Japanese Patent Application Publication No. 2008-251468

### BRIEF DESCRIPTION OF THE DRAWINGS

FIG. 1A illustrates a configuration of a light guide according to the present embodiment.

FIG. 1B illustrates a configuration of a light entrance section and a boundary section.

FIG. 2 illustrates collection of light input to the light guide by the light entrance section and guidance of the light by a light guiding section.

FIG. 3 illustrates design variables of a hollow space.

FIG. 4A illustrates an example of a shape of the hollow space and design parameters for the shape.

FIG. 4B illustrates guidance of light input to the light guide having the hollow space with a polygonal shape.

FIG. 4C illustrates an example of arrangement and period of a plurality of hollow spaces, design parameters related to the arrangement and period.

FIG. 5 illustrates another design example and design parameters of the hollow space.

FIG. 6A illustrates arrangement of the light guide and an incidence angle ¢ of light associated with a diurnal path of the Sun.

FIG. 6B illustrates a light extraction efficiency with respect to the incidence angle ¢ illustrated in FIG. 6A.

FIG. 7A illustrates seasonal variations in solar path and solar altitude.

FIG. 7B illustrates arrangement of the light guide and the solar altitude (noon solar angle) 8.

FIG. 7C illustrates a light extraction efficiency with respect to the solar altitude (incidence angle) θ illustrated in FIG. 7B.

FIG. 8 illustrates an arrangement example of the light guide optimized for the variations in solar altitude.

FIG. 9 illustrates a configuration of a light guide according to a first variant optimized for the variations in solar altitude.

FIG. 10A illustrates definitions of an incidence angle and a diffraction angle of light entering an input section from a light entrance surface.

FIG. 10B illustrates intensity, with respect to a diffraction angle of light that enters the light guide from the light entrance surface having a surface treatment layer and is diffracted.

FIG. 11 illustrates a configuration of a light guide according to a second variant optimized for the variations in solar altitude.

FIG. 12 illustrates a configuration of a light guide according to a third variant optimized for the diurnal path of the Sun in a side view.

FIG. 13 illustrates arrangement in which the light guide according to the third variant is inclined with respect to the noon solar angle.

FIG. 14A illustrates a configuration of a light guide according to a fourth variant optimized for the diurnal path of the Sun in the side view.

FIG. 14B illustrates a configuration of a light guide according to a fifth variant optimized for the diurnal path of the Sun in the side view.

FIG. 15 illustrates a flow of a first manufacturing method of the light guide.

FIG. 16A illustrates an internal state of a mold after a mold/insert setting step in a first manufacturing method in a front view (a cross-section along a reference line AA in FIG. 16B).

FIG. 16B illustrates the internal state of the mold after the mold/insert setting step in the first manufacturing method in a side view (a cross-section along a reference line BB in FIG. 16A).

FIG. 16C illustrates a flow of a resin in a molding step in the first manufacturing method.

FIG. 16D illustrates a state where an insert is extracted in an insert extraction step in the first manufacturing method.

FIG. 17 illustrates a flow of a second manufacturing method of the light guide.

FIG. 18A illustrates the internal state of the mold after a first mold setting step in the second manufacturing method in the front view.

FIG. 18B illustrates a configuration of the light entrance section molded by a light entrance section molding step using a first mold in the second manufacturing method.

FIG. 18C illustrates a configuration of a bottom surface and a continuous section of the light entrance section.

FIG. 18D illustrates the internal state of the mold after a second mold/insert setting step in the second manufacturing method in the front view.

FIG. 18E illustrates the internal state of the mold after the second mold/insert setting step in the second manufacturing method in a perspective view.

FIG. 19 illustrates a flow of a third manufacturing method of the light guide.

FIG. 20A illustrates a configuration of the light entrance section molded by a light entrance section molding step in the third manufacturing method.

FIG. 20B illustrates a configuration of the light guiding section molded by a light guiding section molding step in the third manufacturing method.

FIG. 20C illustrates a state in which the light entrance section and the light guiding section are welded by a welding step in the third manufacturing method.

FIG. 21 illustrates a light guide assembly according to the present embodiment.

FIG. 22 illustrates a principle of the collection of the light input to the light guide assembly by the light entrance section and the guidance of the light by the light guiding section.

FIG. 23 illustrates a configuration and a light focus principle of a light guide assembly according to a variant.

FIG. 24A illustrates a configuration of a light guide with a bottom surface structure according to a sixth variant.

FIG. 24B illustrates guidance of light input to the light guide according to the sixth variant.

FIG. 24C illustrates the guidance of the light input to the light guide according to the sixth variant.

FIG. 24D illustrates the guidance of the light input to the light guide according to the sixth variant.

FIG. 24E illustrates the guidance of the light input to the light guide according to the sixth variant.

FIG. 25A illustrates another example of the bottom surface structure.

FIG. 25B illustrates still another example of the bottom surface structure.

FIG. 26 illustrates a light guide assembly formed by using the light guide according to the sixth variant.

### DESCRIPTION OF EXEMPLARY EMBODIMENTS

Hereinafter, the present invention will be described through embodiments of the invention, but the following embodiments do not limit the invention according to the claims. In addition, not all of the combinations of features described in the embodiments are essential to the solution of the invention.

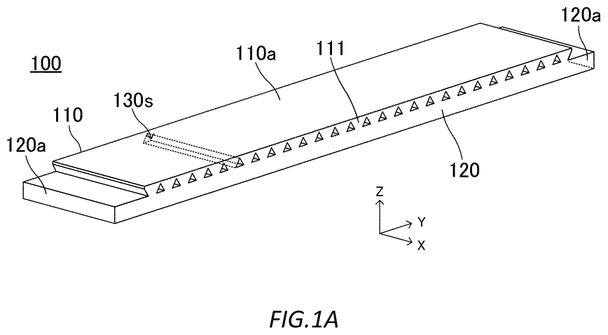

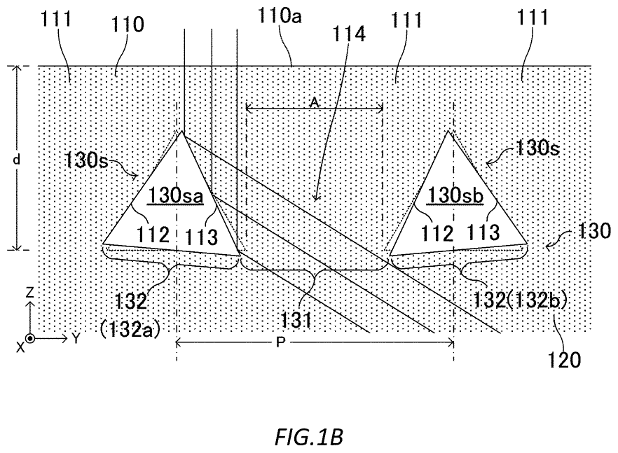

FIGS. 1A and 1B illustrate an overall configuration of a light guide 100 and a configuration of a light entrance section 110 and a boundary section 130 between the light entrance section 110 and a light guiding section 120 according to the present embodiment, respectively. The light guide 100 is an optical device which efficiently collects light input from a light entrance surface 110a and guides the collected light to a light exit surface 120a, which is different from the light entrance surface 110a, so that the light is output without leakage or with minimal leakage, and includes the light entrance section 110, the light guiding section 120 and the boundary section 130. Note that, the light guide 100 generally has a substantially plate-like shape which bidimensionally expands in an X axis direction as a transverse direction and a Y axis direction as a longitudinal axis and has a thickness in a Z axis direction.

The light entrance section 110 is an optical member which collects light input in an input direction (in the present embodiment, a −Z direction) via the light entrance surface 110a, and includes a plurality of light collecting elements 111. The plurality of light collecting elements 111 are columnar members each of which has a cross-section having an inverted substantially isosceles trapezoidal shape with a maximum width P in the Y axis direction and a height d in the Z axis direction and extends in the X axis direction, and are arrayed in parallel in the Y axis direction such that +Z sides of Y side surfaces (that is, a +Y side surface and a −Y side surface) are in contact with one another and −Z sides are spaced apart from one another. In the present embodiment, the plurality of light collecting elements 111 are integrally molded to be connected to one another (however, the light entrance section 110 is described to include the plurality of light collecting elements 111 for convenience of description of the configuration and functionality of the light entrance section 110). As a result, the light entrance section 110 is formed to extend in the Y axis direction, and +Z surfaces of the plurality of light collecting elements 111 are connected to one another to form the light entrance surface 110a in a planar shape with a width in the X axis direction. In this manner, the light entrance surface 110a is provided such that light is input from a +Z side. In addition, two of the light collecting elements 111 adjacent to one another form a hollow space (also simply referred to as a space) 130s having a triangular cross-section and extending in the X axis direction therebetween.

Note that the plurality of light collecting elements 111 may be arrayed in parallel to be spaced apart from one another in the Y axis direction. In such a case, each of the +Z surfaces of the plurality of light collecting elements 111 serves as an independent light entrance surface.

Each of the light collecting elements 111 has reflective surfaces 112 and 113 and a light transmitting section 114 positioned below (in the −Z direction from) the light entrance surface 110a. Here, each of the light collecting elements 111 can be formed by using, for example, a resin having a high refractive index such as an acrylic resin (refractive index: 1.49) and a polycarbonate resin (refractive index: 1.58), or glass (refractive index: 1.51 to 1.53 for BK7, for example). A boundary between each of the light collecting elements 111 and the space 130s, that is, each of the +Y side surfaces of each of the light collecting elements 111 serves as each of reflective surfaces 112 and 113 which reflect a part of the light input into each of the light collecting elements 111 via the light entrance surface 110a. The light is totally reflected when the light enters from an inside of each of the light collecting elements 111 to the +Y side surfaces at an angle equal to or greater than a critical angle. The critical angle is approximately 42 degrees for the acrylic resin, approximately 41 degrees for the polycarbonate resin, and approximately 42 degrees for the glass. Thus, the +Y side surfaces of each of the light collecting elements 111 are formed such that each of their normals forms an angle equal to or greater than the critical angle with the input direction (that is, the Z axis direction in the present embodiment) of the light. Meanwhile, a portion between the reflective surfaces 112 and 113 of each of the light collecting elements 111 serves as the light transmitting section 114 which transmits a part of light input from the light entrance surface 110a (that is, a remaining part which does not enter the reflective surfaces 112 and 113 in the present example), and reflected light reflected by the reflective surfaces 112 and 113.

The reflective surfaces 112 and 113 are respectively positioned on a +Y side and a −Y side of the light transmitting section 114 and are arranged to be opposed to one another, and are provided so as to reflect the light input from the light entrance surface 110a toward the light transmitting section 114. Here, each of the reflective surfaces 112 and 113 are formed in a linear shape on an YZ cross-section. In addition, in order to increase a reflectance, the reflective surfaces 112 and 113, that is, the +Y side surfaces of each of the light collecting elements 111 may be mirror-finished. In addition, a reflective film may be provided by using metal or the like.

The light guiding section 120 is an optical member that has the light exit surface 120a which is positioned on the −Z side with respect to the light entrance section 110, and further guides the reflected light reflected by the reflective surfaces 112 and 113 of the light entrance section 110 in a +Y direction and/or a −Y direction and outputs the reflected light from the light exit surface 120a. The light guiding section 120 is formed to have a plate-like shape which extends in the Y axis direction. Here, a width of the light guiding section 120 in the X axis direction is equal to (may be larger than) a width of the light entrance section 110, a length of the light guiding section 120 in the Y axis direction is larger than (may be equal to) a length of the light entrance section 110, and a thickness of the light guiding section 120 in the Z axis direction is larger than a thickness of the light entrance section 110 (may be arbitrarily determined). The +Y side surface and/or the −Y side surface of the light guiding section 120 form the light exit surface 120a through which the light is output and the −Z end surface 120b is formed to have a planar shape so that it serves as a reflective surface which reflects the light guided within the light guiding section 120 toward an inside.

Note that the light guiding section 120 can be formed using a same material as the light entrance section 110 (light collecting elements 111). In order to increase the reflectance, the −Z end surface 120b of the light guiding section 120 may be mirror-finished. In addition, a reflective film may be provided by using metal or the like.

Note that, on a light guide path for light from the light entrance surface 110a of the light entrance section 110 to the light exit surface 120a of the light guiding section 120, the light entrance section 110 is arranged on the light entrance surface 110a side with respect to the light guiding section 120 and the light guiding section 120 is arranged on the light exit surface 120a side with respect to the light entrance section 110.

The boundary section 130 is positioned at a boundary between the light entrance section 110 and the light guiding section 120, and includes a continuous section 131 and a non-continuous section 132.

The continuous section 131 is provided to physically continuously connect the light transmitting section 114 of the light entrance section 110 and the light guiding section 120 to guide, within the light guiding section 120, light input from the light entrance surface 110a, that is, the reflected light reflected by the reflective surfaces 112 and 113 and the remaining light which has not entered the reflective surfaces 112 and 113. The continuous section 131 has an aperture width A in the Y axis direction and extends in the X axis direction. Note that the continuous section 131 can be formed of a same material as the light collecting elements 111. In addition, the continuous section 131 may be integrally formed with the light entrance section 110 and/or the light guiding section 120 as a part thereof.

The non-continuous section 132 is provided so that the reflective surfaces 112 and 113 of the light entrance section 110 and the light guiding section 120 are spaced apart from one another, and is arranged adjacent to each of the +Y sides of the continuous section 131. Since the light guiding section 120 is spaced apart from the light entrance section 110 (the reflective surfaces 112 and 113 formed on the +Y side surfaces) by the non-continuous section 132 to form the space 130s therebetween, an interface between the non-continuous section 132 and the light guiding section 120 serves as a reflective surface which reflects reflected light input from the light transmitting section 114 of the light entrance section 110 via the continuous section 131 to the light guiding section 120 to be guided to the light exit surface 120a. Note that in order to increase the reflectance, the interface between the non-continuous section 132 and the light guiding section 120, that is, a +Z end surface of the light guiding section 120 under the space 130s may be mirror-finished. In addition, a reflective film may be provided by using metal or the like.

In the present embodiment, the light entrance section 110 is formed by arraying the light collecting elements 111 in parallel in the Y axis direction, so that a plurality of reflective surfaces 112 and 113, each being the reflective surfaces 112 and 113, and a plurality of light transmitting sections 114, each being light transmitting section 114, of the light entrance section 110 are arranged in the light entrance section 110 along the Y axis direction. Correspondingly, a plurality of continuous sections 131, each being the continuous section 131, and a plurality of non-continuous sections 132, each being the non-continuous section 132, are each provided at the boundary between the light entrance section 110 and the light guiding section 120, and the plurality of continuous sections 131 and the plurality of non-continuous sections 132 are alternately arranged along the Y axis direction. Here, the continuous section 131 has a width A (which is equal to a width of the light transmitting section 114) in the Y axis direction and are periodically arrayed with a pitch P in the Y axis direction. The non-continuous section 132 has a width substantially equal to the continuous section 131 in the present embodiment, and is arranged adjacent to the continuous section 131 or between the continuous sections 131. As a result, an aperture ratio A/P is about 1/2. Note that the continuous section 131 and the non-continuous section 132 adjacent thereto may have widths different from one another in the Y axis direction, and the aperture ratio A/P may be greater or smaller than about 1/2.

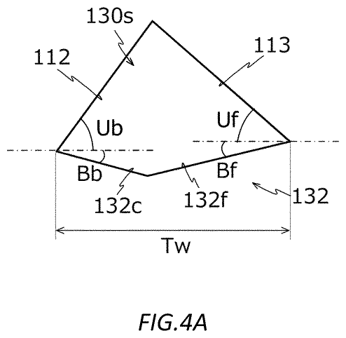

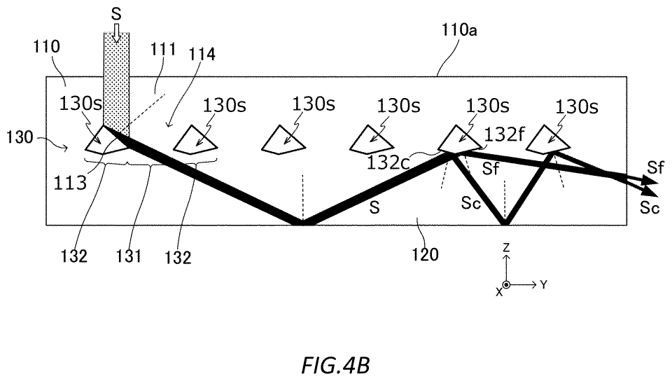

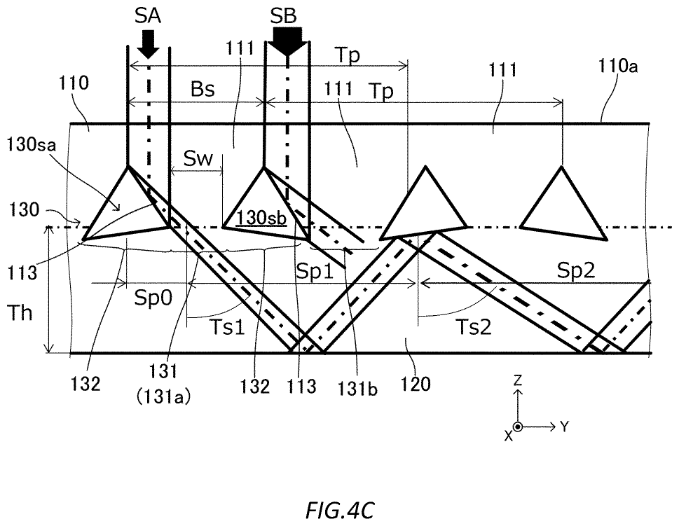

Here, the plurality of non-continuous sections 132, that is, the plurality of non-continuous sections 132 arrayed in the Y axis direction via the continuous sections 131 have widths equal or substantially equal to one another in the Y axis direction. On the other hand, the plurality of continuous sections 131 may include a first-width continuous section 131a having a width of a first length in the Y axis direction and a second-width continuous section 131b having a width of a second length different from the first length (see FIG. 4C), and the first-width continuous section 131a and the second-width continuous section 131b may be alternately arranged via the non-continuous section 132.

As illustrated in FIG. 1B, the reflective surfaces 112 and 113 of the light entrance section 110 reflect the light input from the light entrance surface 110a toward the continuous section 131. In particular, the reflective surfaces 112 and 113 reflect the light input from a direction orthogonal to the light entrance surface 110a (the Z axis direction in the present embodiment) toward the continuous section 131. Here, the light reflected by the reflective surface 112 passes through the continuous section 131 while forming collimated light, in other words, the light reflected on the +Z side of the reflective surface 112 passes through the +Y side of the continuous section 131, the light reflected at a middle part of the reflective surface 112 passes through a middle part of the continuous section 131, and the light reflected on the −Z side of the reflective surface 112 passes through the −Y side of the continuous section 131, so that the light enters the light guiding section 120. Note that the light reflected by the reflective surface 113 enters the light guiding section 120 while forming collimated light, similarly to the light reflected by the reflective surface 112 except that a direction in which the light is heading is opposite.

Note that the non-continuous section 132 includes a non-continuous section 132b provided so that the reflective surface 112 and the light guiding section 120 are spaced apart from one another and a non-continuous section 132a provided so that the reflective surface 113 and the light guiding section 120 are spaced apart from one another by being arranged below the reflective surfaces 112 and 113 of the light entrance section 110. In addition, by arraying the light collecting elements 111 in parallel in the Y axis direction within the light entrance section 110, the space 130s which has a cross-section having a triangular shape, when viewed from the Y direction, is formed on an inside of the Y side surfaces of two of the light collecting elements 111 adjacent to one another and the non-continuous section 132 (the +Z end of the light guiding section 120), and the reflective surfaces 112 and 113 of the two of the light collecting elements 111 adjacent to one another face away from one another via the space 130s, so that the non-continuous sections 132 positioned below them are continuously connected. That is, the reflective surfaces 112 and 113 (examples of third and fourth reflective surfaces) that face away via the space 130s are positioned on the +Y end side and the −Y end side of the non-continuous section 132 with respect to the Y axis direction, respectively, and are inclined in different orientations with respect to the Y axis direction (face a −Y/+Z direction and a +Y/+Z direction, respectively).

Further, an end, on a light guiding section 120 side, of the non-continuous section 132 (that is, the interface between the light guiding section 120 and the non-continuous section 132) is inclined with respect to the Y axis direction. Here, interfaces between the light guiding section 120 and respective ones of the non-continuous sections 132 adjacent thereto are inclined in different orientations with respect to the Y axis direction. An interface between the light guiding section 120 and the non-continuous section 132a is inclined in a clockwise direction with respect to the Y axis and an interface between the light guiding section 120 and the non-continuous section 132b is inclined in an anti-clockwise direction with respect to the Y axis. The non-continuous sections 132 arrayed in the Y axis direction include the non-continuous sections 132a and the non-continuous sections 132b, which are alternately arrayed.

Further, the reflective surfaces 112 and 113, being opposed to one another, included in one of the light collecting elements 111 have opposite and equal angles of inclination with respect to the Z axis. Here, the angles of inclination may be different from one another in each of the light collecting elements 111 adjacent to one another or may be alternately different. The reflective surfaces 112 and 113 facing away from one another via the space 130s between the two of the light collecting elements 111 adjacent to one another have different angles of inclination. Note that triangular cross-sections of a plurality of spaces 130s, each being the spaces 130s, arranged side by side in the Y axis direction may be alternately rotated in different directions. Here, the plurality of spaces 130s is rotated about a reference axis parallel to the X axis direction passing through a center of each of the spaces 130s on a YZ plane. In the present example, a space 130sa on a left side is rotated clockwise and a space 130sb on a right side is rotated anti-clockwise from a state before rotation which is illustrated in a dotted line in the figure (a state where a base of the triangle is parallel to the Y axis direction). As a result, the space 130sa rotated clockwise and the space 130sb rotated anti-clockwise are alternately arrayed in the Y axis direction.

Note that when the plurality of spaces 130s are not rotated, the boundary section 130 between the light entrance section 110 and the light guiding section 120 forms a straight line extending in the Y axis direction in the YZ plane and the continuous section 131 and the non-continuous section 132 are also continuously linearly connected in the YZ plane. When the plurality of spaces 130s are rotated, the boundary section 130 forms a non-straight line extending in the Y axis direction to be repeatedly bent in +Z directions in the YZ plane and the continuous section 131 and the non-continuous section 132 are also continuously non-linearly connected in the YZ plane.

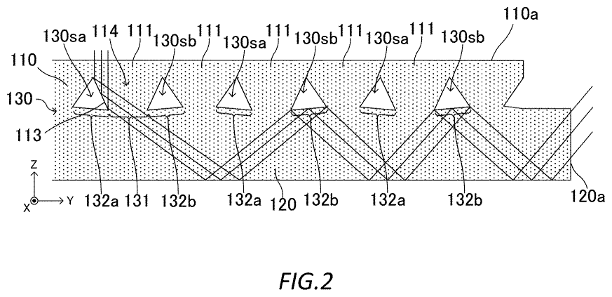

FIG. 2 illustrates collection of the light input to the light guide 100 by the light entrance section 110 and guidance of the light by the light guiding section 120. As an example, an optical path of light entering in the −Z direction from the light entrance surface 110a and reflected by the reflective surface 113 (a right-side inclined surface of the space 130sa on a leftmost side in the figure) of the light entrance section 110 is illustrated. Since the aperture width A of the continuous section 131 is large (the aperture ratio A/P is nearly equal to 0.5) as described above, light reflected by the reflective surface 113 (reflected light) passes through the continuous section 131 while keeping collimated and enters the light guiding section 120. The reflected light entering the light guiding section 120 is guided within the light guiding section 120 rightward so that the light is output from the light exit surface 120a, by being reflected by the −Z end surface 120b of the light guiding section 120 and returned in the +Z direction, and reflected at an interface with the non-continuous section 132, in the present example, reflected at an interface with the non-continuous section 132b below the third space 130sb to the right from the space 130sa below the reflective surface 113, reflected by the −Z end surface 120b of the light guiding section 120 and returned in the +Z direction, and reflected at an interface with the non-continuous section 132b below the second space 130sb further to the right from the space 130sb. Since interfaces between the non-continuous sections 132 (non-continuous sections 132a and 132b) arrayed in the Y axis direction and the light guiding section 120 are inclined in alternately different orientations and, further, the reflective surfaces 112 and 113 of the light collecting elements 111 arrayed in the Y axis direction have alternately different angles of inclination (absolute values of angles of inclination with respect to the Z axis), the light reflected by the reflective surface 113 is guided within the light guiding section 120 by being reflected at the interface of the same non-continuous section 132 (the non-continuous section 132b in the present example). Note that the angles of inclination of the non-continuous sections 132a and 132b and/or the angles of inclination of the reflective surfaces 112 and 113 are determined such that the light entering the light guiding section 120 from the light collecting elements 111 does not leak from the light guide 100 in the +Z direction via the light transmitting section 114 of each of the light collecting elements 111 different from one another, in other words, is reflected by the interfaces with the plurality of non-continuous section 132.

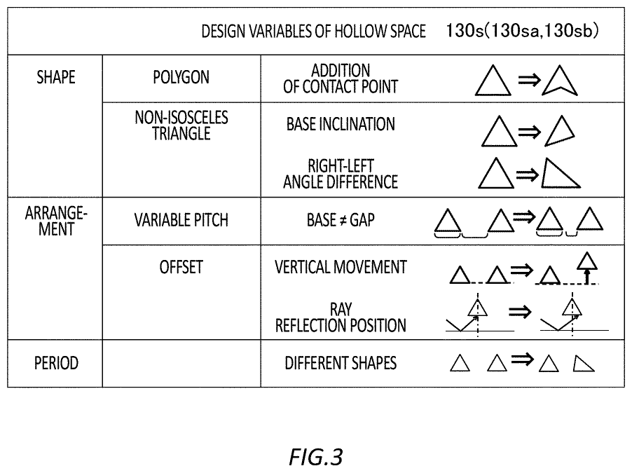

FIG. 3 illustrates design variables of the hollow space 130s. Here, in particular, main design variables are shown to maximize a light guiding distance of the light entering the light guide 100. The design variables are grouped into three variable groups of shape, arrangement, and period.

The variable group of the shape includes design variables related to the cross-sectional shape of the space 130s when viewed in the X direction. Here, two shapes of a polygon and a non-isosceles triangle are adopted as main shapes of the space 130s. Design variables of the polygon use a triangle as a basic shape, and include addition of a contact point for defining a polygon with respect to the triangle. For example, a quadrangular shape (a wedge shape in the present example) is derived by adding one contact point to the basic shape. Design variables of the non-isosceles triangle include a base inclination and a right-left angle difference. The base inclination includes inclination of a bottom surface (−Z surface) of the space 130s, that is, a base of the cross-sectional shape when viewed in the X direction. For example, a deformed triangle can be derived by inclining a base of the triangle as the basic shape rightward and downward. The right-left angle difference includes providing a difference in inclination angle between right and left oblique sides (that is, the reflective surfaces 112 and 113) of the triangle as the basic shape. For example, by making the angle of the right oblique side with respect to the base smaller than that of the left oblique side, a triangular shape elongated to the right is derived.

FIG. 4A illustrates an example of the shape of the hollow space 130s and design parameters for the shape. In addition of a contact point, a quadrangular shape is derived by adding one contact point to the base of the triangle of the basic shape, inclinations of two bases (a left non-continuous section 132c and a right non-continuous section 132f of the non-continuous section 132), that is, a rear-lower inclined surface angle Bb and a front-lower inclined surface angle Bf are determined by the inclination of the base, and inclinations of two oblique sides (reflective surfaces 112 and 113), that is, a rear-upper inclined surface angle Ub and a front-upper inclined surface angle Uf are determined by the right-left angle difference.

FIG. 4B illustrates guidance of light S input to the light guide 100 having the hollow space 130s with a polygonal shape. In the present example, the spaces 130s having a rhombic cross-section illustrated in FIG. 4A are arrayed at equal intervals in the Y axis direction. The light S entering the light entrance section 110 via the light entrance surface 110a and entering a right oblique side (that is, the reflective surface 113) of a first space 130s is reflected by the reflective surface 113, enters the light guiding section 120 via the continuous section 131, and is reflected by the bottom surface of the light guiding section 120 toward a bottom surface of a second space 130s. Here, since the bottom surface of the space 130s includes two surfaces (the left non-continuous section 132c and the right non-continuous section 132f illustrated in FIG. 4A) facing directions different from one another, the light S is split into two lights Sc and Sf. The light Sc is reflected by the bottom surface of the light guiding section 120 at a small angle with respect to the Z axis direction toward the bottom surface of the space 130s which is adjacent thereto, is reflected again by the bottom surface, and is guided in the +Y direction within the light guiding section 120. The light Sf is reflected at a large angle on the bottom surface of the light guiding section 120 and guided in the +Y direction within the light guiding section 120. In this manner, the light is appropriately split, and each split light is reflected in an appropriate direction on the bottom surface of the space 130s, so that a light guiding distance in the Y direction in the light guiding section 120 can be increased.

The variable group of the arrangement includes design variables related to the arrangement of the space 130s in the Y axis direction. Here, a variable pitch and an offset are adopted as arrangement variables of the space 130s. Design variables of the variable pitch includes setting a width (a texture width Tw in FIG. 4A) of the bottom surface (non-continuous section 132) of the space 130s in the Y axis direction, and making a width of a gap (continuous section 131) between two of the spaces 130s equal to or different from the width of the bottom surface. For example, by making the gap between the two spaces 130s smaller than the width of the bottom surface, a dense array of the spaces 130s is derived. Design variables of the offset include vertical movement and a ray reflection position. Design variables of the vertical movement includes that some spaces 130s of the plurality of spaces 130s arrayed in the Y axis direction are offset upward (+Z direction) or downward (−Z direction) with respect to other spaces 130s. For example, arrangement in which the space on a right side is offset upward with respect to the space 130s on a left side is derived. Design variables of the ray reflection position include a ray position incident on the bottom surface of the space 130s. For example, arrangement in which an incident position of a ray is shifted from a center of the bottom surface of the space 130s to a center right is derived.

The variable group of the period includes design variables related to the array of the space 130s in the Y axis direction. Here, period variables of the space 130s include different shapes. Design variables of the different shapes includes that a cross-sectional shape of some spaces 130s of the spaces 130s among the plurality of spaces 130s arrayed in the Y axis direction is made different from a cross-sectional shape of other spaces 130s. For example, array in which the space 130s having an equilateral triangular cross-section and the space 130s having a triangular cross-section elongated to the right are alternately arranged in the Y axis direction is derived.

FIG. 4C illustrates an example of the arrangement and the period of the plurality of hollow spaces 130s, and design parameters related to the arrangement and the period. Note that, as design parameters of the arrangement, a light guide path of light SA entering a right oblique side (reflective surface 113) of the space 130sa is illustrated as an example. Here, the shape and the period of the space 130s are adopted such that no contact point is added (triangle cross-section), the base of the triangle cross-section is inclined obliquely downward to the left (in a −Y/−Z direction) or obliquely downward to the right (in a +Y/−Z direction) due to the base inclination, an angle difference between a left oblique side and a right oblique side (reflective surfaces 112 and 113) is provided due to the right-left angle difference, and due to the different shapes, the space 130sa having the base inclined obliquely downward to the left and the space 130sb inclined obliquely downward to the right are alternately arranged in the Y axis direction. In addition to this, the texture width Tw (see FIG. 4A) of the bottom surface (non-continuous section 132) of the spaces 130sa and 130sb in the Y axis direction and a propagation ray projection width Sw (a width of the continuous section 131) are determined by the variable pitch, an array pitch (that is, a texture pitch) Tp of the spaces 130sa and 130sb by the variable pitch and an array pitch deviation Bs between the spaces 130sa and 130sb are determined by the variable pitch, a height (that is, a texture height) of the spaces 130sa and 130sb is are determined by a vertical movement, and a propagation ray initial deviation amount Sp0, propagation ray pitches Sp1, Sp2, and so on which are pitches of a reflection position of a ray on an interface between the light entrance section 110 and the light guiding section 120, and propagation ray angles Ts1, Ts2, and so on which are reflection angles of the ray on the bottom surfaces of the spaces 130sa and 130sb are determined by the ray reflection position.

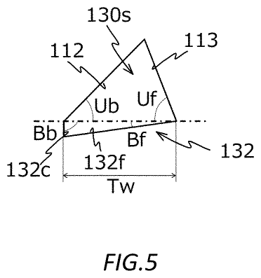

FIG. 5 illustrates another design example and design parameters of the hollow space 130s. When the cross-sectional shape of the space 130s is a triangular shape (no contact point addition) and the base is inclined due to the base inclination, the texture width Tw increases, and accordingly, the propagation ray projection width Sw (the width of the continuous section 131) decreases or the texture pitch Tp increases, and an optimal design parameter may not be determined. In such a case, it is possible to incline the base without changing the texture width Tw, the propagation ray projection width Sw, and the texture pitch Tp by adding a contact point to set the shape to a quadrangular shape and setting the rear-lower inclined surface angle Bb to 90 degrees, for example, by the base inclination.

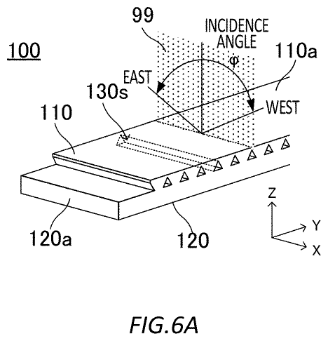

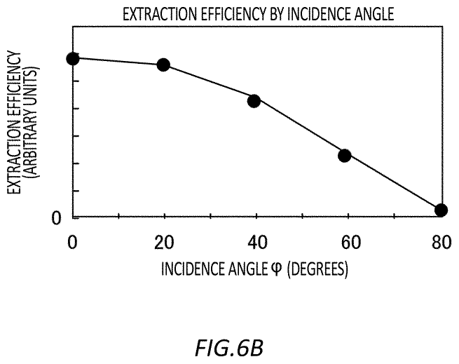

FIG. 6A illustrates arrangement of the light guide 100 and an incidence angle ¢ of light associated with a diurnal path of the Sun. The light guide 100 is arranged such that an extending direction (that is, the X axis direction) of the continuous section 131 is substantially parallel to a plane (movement trajectory plane) 99 including a movement trajectory associated with a diurnal cycle of the Sun, and such that a normal direction of the light entrance surface 110a is substantially parallel to the movement trajectory plane 99, that is, such that the light collecting element 111 faces substantially parallel to the movement trajectory plane 99. The incidence angle ¢ of light is determined with reference to the normal direction of the light entrance surface 110a. Here, the movement trajectory plane 99 of the Sun is formed by a trajectory of an orbital motion of the Sun.

FIG. 6B illustrates a light extraction efficiency of the light guide 100 with respect to the incidence angle ϕ illustrated in FIG. 6A. The extraction efficiency can be analyzed by so-called ray simulation, and is calculated by dividing an amount of the light output from the light exit surface 120a by an amount of the light input to the light entrance surface 110a. When the incidence angle ϕ is 0 (perpendicularly incident on the light entrance surface 110a), a large part of the light entering the light entrance section 110 via the light entrance surface 110a is guided within the light guiding section 120 and output from the light exit surface 120a. However, the extraction efficiency gradually decreases as the incidence angle increases above 20 degrees, and is almost zero when the incidence angle is 80 degrees. It can be seen that a high extraction efficiency can be obtained at least in a range of the incidence angle of 0 degrees to 40 degrees, that is, for a long period of time in hours of sunlight.

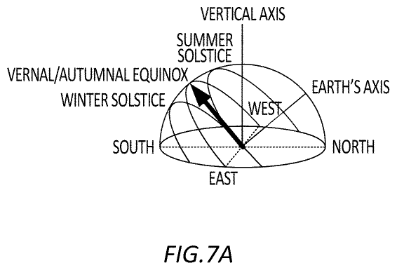

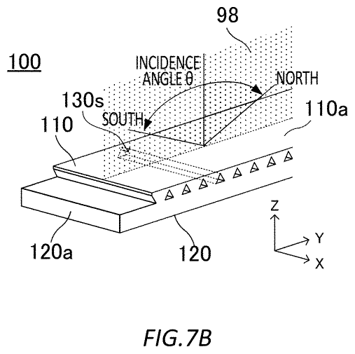

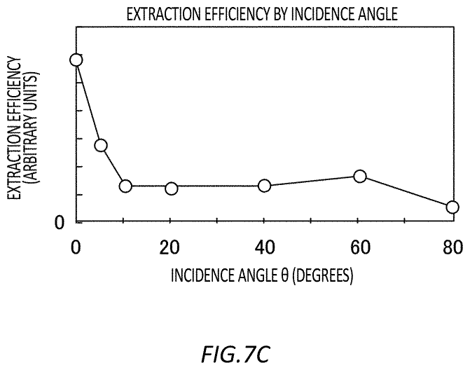

FIG. 7A illustrates seasonal variations in the diurnal path of the Sun and solar altitude (noon solar altitude). The sun rises from the east of a ground surface, goes south, and sinks to the west due to a diurnal motion. Here, a diurnal path changes according to the season, and the solar altitude is the highest in the summer solstice and the lowest in the winter solstice.

FIG. 7B illustrates arrangement of the light guide 100 and a solar altitude (also referred to as a noon solar angle) θ. The light guide 100 is arranged such that an array direction of the spaces 130s or the continuous sections 131 (that is, Y axis direction) is approximately parallel to a north-south plane 98 that defines the solar altitude, and such that the normal direction of the light entrance surface 110a is also approximately parallel to the north-south plane 98, that is, such that the light collecting element 111 faces a vertical direction. The incidence angle θ of light is determined with reference to the normal direction of the light entrance surface 110a.

FIG. 7C illustrates a light extraction efficiency with respect to the solar altitude (incidence angle) θ illustrated in FIG. 7B. The extraction efficiency can be analyzed by so-called ray simulation, and is calculated by dividing the amount of the light output from the light exit surface 120a by the amount of the light input to the light entrance surface 110a. When the incidence angle θ is 0 (perpendicularly incident on the light entrance surface 110a), a large part of the light entering the light entrance section 110 via the light entrance surface 110a is guided within the light guiding section 120 and output from the light exit surface 120a. However, when the incidence angle increases even slightly (exceeding approximately 3 degrees), the extraction efficiency sharply decreases, reaching a minimum around an incidence angle of 10 degrees.

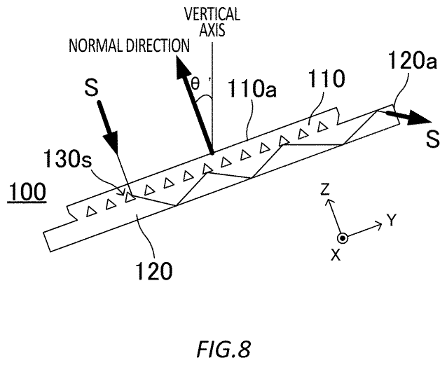

FIG. 8 illustrates an arrangement example of the light guide 100 optimized for the variations in solar altitude. The light guide 100 is arranged such that a light guide direction (that is, the Y axis direction) of the light guiding section 120 is substantially perpendicular to a plane (the movement trajectory plane 99 in FIG. 6A) including a movement trajectory of the Sun (a movement trajectory associated with the diurnal motion). That is, the light guide 100 is inclined by an angle θ′ according to the noon solar altitude of the Sun, particularly, such that the normal direction of the light entrance surface 110a falls within a range of approximately −3 to 3 degrees relative to the solar altitude. As a result, the incidence angle θ of the light S falls within the range of −3 to 3 degrees, and the light extraction efficiency can be maximized. Note that, for example, the inclination of the light guide 100 may be adjusted a plurality of times throughout a year such as four times of the vernal equinox, the summer solstice, the autumnal equinox, and the winter solstice, and the normal direction of the light entrance surface 110a may substantially coincide with the solar altitude.

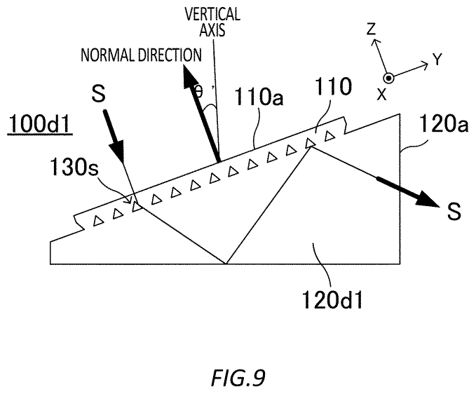

FIG. 9 illustrates a configuration of a light guide 100d1 according to a first variant optimized for the variations in solar altitude. The light guide 100d1 includes a light guiding section 120d1 in which a thickness (a thickness in the Z axis direction) increases in the +Y direction. Here, the light guiding section 120d1 has a substantially right triangular shape in a front view having an upper surface inclined by the angle θ′ with respect to the Y axis direction and a bottom surface parallel to a horizontal plane. The light entrance section 110 is arranged on the upper surface of the light guiding section 120. As a result, the light entrance section 110 can be inclined substantially equally to the solar altitude while the light guide 100 is installed on the horizontal plane, so that the light extraction efficiency can be maximized similarly to the light guide 100 illustrated in FIG. 8.

The light entrance surface 110a of the light entrance section 110 may be surface-treated so that light from a wide angular range enters the light entrance section 110 substantially perpendicularly. A surface treatment layer 110b which is surface-treated as described above is provided on the light entrance surface 110a. The surface treatment layer 110b includes, for example, a diffractive optical element and a moth-eye structure. As the diffractive optical element, for example, a diffractive element in which frustoconical fine patterns extending in the Z axis direction and having a structure or a period with a length of 100 nm or more and 10 μm or less are arrayed in an XY direction can be adopted, and an oblique grating formed by arraying plate-like lattices, which are inclined with respect to the Z axis direction, in the Y axis direction with their longitudinal direction oriented in the X axis direction can be adopted. The moth-eye structure is a structure which is formed such that the refractive index continuously changes in the Z axis direction, by arraying, in the XY direction, fine protrusions extending in the Z axis direction and having a structure with a length of 100 nm or more and 10 μm or less.

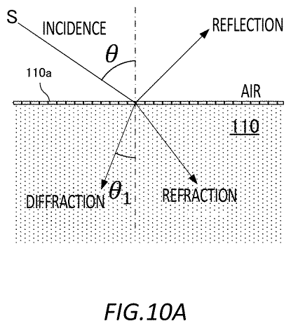

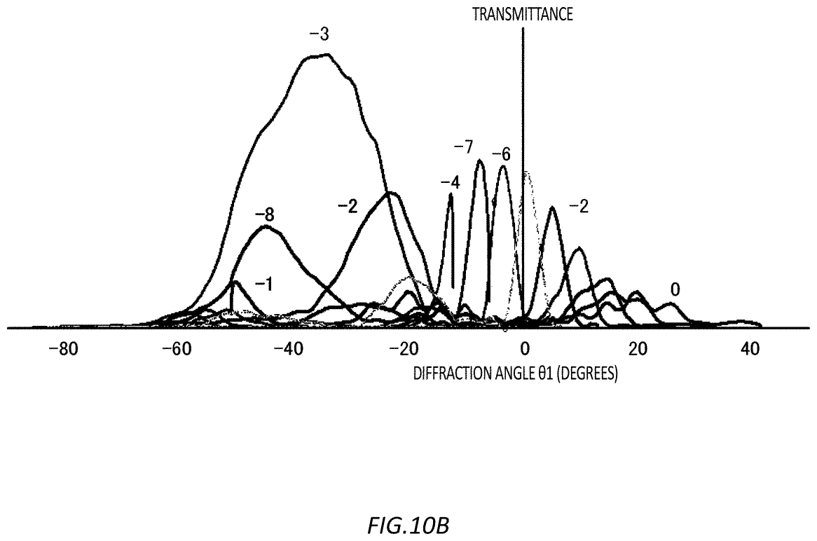

FIG. 10A illustrates definitions of the incidence angle θ and a diffraction angle θ1 of the light S entering the light entrance section 110 from the light entrance surface 110a. The incidence angle θ of the light S is determined by an angle with respect to the normal direction (indicated by a one-dot chain line) of the light entrance surface 110a. When entering the light entrance section 110 having a different refractive index from an air layer, the light S is diffracted through the surface treatment layer 110b. The diffraction angle θ1 is also determined by the angle with respect to the normal direction (indicated by the one-dot chain line) of the light entrance surface 110a. Note that, when the surface treatment layer 110b is not provided on the light entrance surface 110a, the light is refracted when entering the light entrance section 110.

FIG. 10B illustrates transmittance, with respect to the diffraction angle θ1, of light that enters the light entrance section 110 from the light entrance surface 110a having the surface treatment layer 110b and is diffracted. Note that numbers in the figure indicate diffraction orders. Here, as an example, the surface treatment layer 110b adopts a diffractive optical element in which frustoconical fine patterns having a structure or a period with a length of 100 nm or more and 10 μm or less are arrayed. The light S is diffracted by entering the surface treatment layer 110b, and diffracted light of orders from 0th to-8th spreads within an angular range of −60 to 40 degrees. Here, the diffracted light of −2nd, −4th, −6th, and −8th orders spreads with high transmittance within an angular range of −20 to 20 degrees. Thus, by providing the surface treatment layer 110b on the light entrance surface 110a and forming the surface treatment layer 110b such that the diffracted light (for example, the diffracted light of the −2nd, −4th, −6th, and −8th orders) is concentrated in a range of the diffraction angle θ1 with respect to the solar altitude and guided in the Z axis direction, it is possible to guide the light in the Y axis direction within the light guide 100, thereby improving the light extraction efficiency.

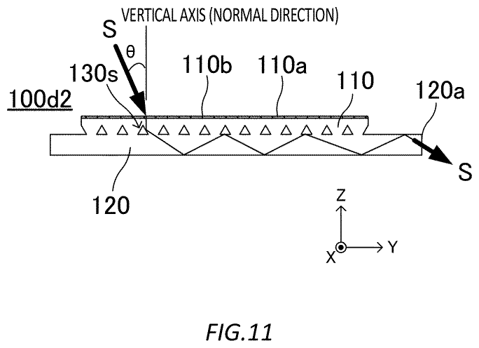

FIG. 11 illustrates a configuration of a light guide 100d2 according to a second variant optimized for the variations in solar altitude. The light guide 100d2 includes the surface treatment layer 110b formed on the light entrance surface 110a. For example, the surface treatment layer 110b may adopt a diffractive optical element in which tabular fine patterns having a structure or a period with a length of 100 nm or more and 10 μm or less are arrayed in the XY direction. By designing the fine shape pattern such that a large part of the diffracted light is diffracted at a diffraction angle of substantially 0 or in a diffraction angle range near 0 when light is incident at the incidence angle θ in the YZ plane, a large part of the light S entering the light entrance surface 110a at the noon solar angle (incidence angle θ) can be oriented in the Z axis direction within the light entrance section 110 and guided to the light guiding section 120.

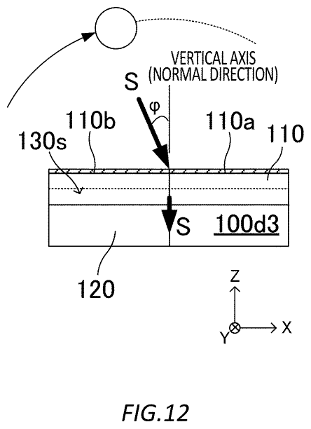

FIG. 12 illustrates a configuration of a light guide 100d3 according to a third variant optimized for the diurnal path of the Sun in the side view. The light guide 100d3 includes the surface treatment layer 110b formed on the light entrance surface 110a. For example, the surface treatment layer 110b may adopt a diffractive optical element in which frustoconical fine patterns are arrayed in the XY direction. By designing the fine shape pattern such that a large part of the diffracted light is diffracted at a diffraction angle of substantially 0 or in a diffraction angle range near 0 when light is incident at the incidence angle ϕ in the XZ plane, a large part of the light S entering the light entrance surface 110a at the incidence angle ϕ can be oriented in the Z axis direction within the light entrance section 110 and guided to the light guiding section 120.

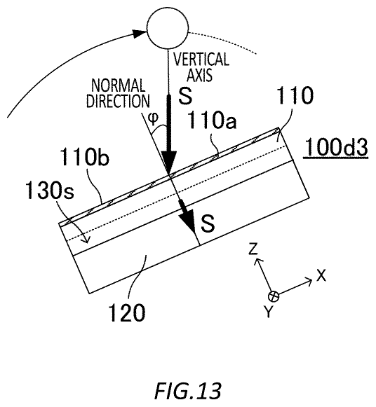

Note that as illustrated in FIG. 13, the light guide 100 may be inclined about the Y axis such that the light enters the light entrance surface 110a at the incidence angle ϕ with respect to the noon solar altitude. As a result, it is possible to allow strong sunlight at solar noon to enter the light entrance surface 110a, maximizing the amount of light guided to the light guiding section 120.

Meanwhile, from FIG. 10B, it can be seen that the diffracted light of, particularly, a −3th order, as well as the −2nd and −8th orders, spreads with high transmittance within an angular range of −50 to −20 degrees. Thus, by providing the surface treatment layer 110b on the light entrance surface 110a and forming the surface treatment layer 110b such that the diffracted light (for example, the diffracted light of the −3th order) is concentrated in a range of the diffraction angle θ1 with respect to the diurnal altitude of the Sun and guided in the Z axis direction, it is possible to guide the light in the Y axis direction within the light guide 100, improving the light extraction efficiency. For example, the light guide 100 in which the surface treatment layer 110b is provided on the light entrance surface 110a can be arranged such that an intersection line between a plane including the movement trajectory of the Sun (the movement trajectory plane 99 in FIG. 6A) and the light entrance surface 110a is inclined with respect to the horizontal direction.

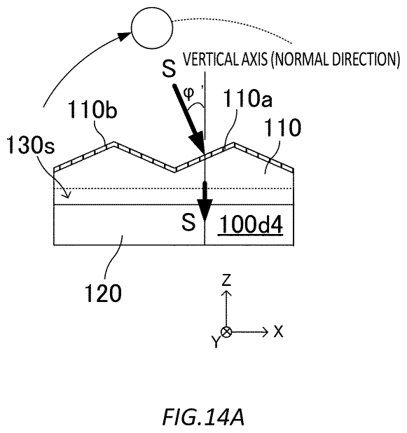

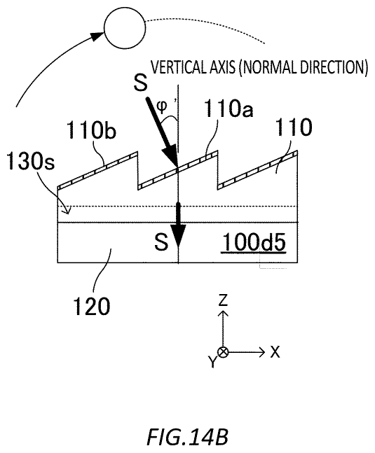

FIGS. 14A and 14B illustrate configurations of light guides 100d4 and 100d5 according to fourth and fifth variants optimized for the diurnal path of the Sun in the side view. The light guides 100d4 and 100d5 each includes the light entrance section 110 having the light entrance surface 110a inclined about the Y axis with respect to the light guiding section 120 extending in the XY direction.

The light entrance section 110 of the light guide 100d4 has the light entrance surface 110a having an inverted W shape including two inclined surfaces facing a −X/+Z direction and two inclined surfaces facing a +X/+Z direction in the side view. On the light entrance surface 110a, for example, the surface treatment layer 110b including a diffractive optical element in which frustoconical fine patterns having a structure or a period with a length of 100 nm or more and 10 μm or less are arrayed in the XY direction may be provided. By designing the fine shape pattern such that a large part of the diffracted light is diffracted in the substantially Z axis direction or in a diffraction angle range near the Z axis when light enters the inclined surface inclined by an angle ϕ′ with respect to a vertical axis in the XZ plane in the −X/+Z direction, a large part of the light S entering the light entrance surface 110a can be directed in the Z axis direction within the light entrance section 110 and guided to the light guiding section 120. Note that, due to symmetry of the diffractive optical element, even when light enters the inclined surface inclined in the +X/+Z direction in an orientation opposite to the above, a large part of the light S entering the light entrance surface 110a can be directed in the Z axis direction within the light entrance section 110 and guided to the light guiding section 120.

The light entrance section 110 of the light guide 100d5 has the light entrance surface 110a having a sawtooth shape including three inclined surfaces facing the −X/+Z direction in the side view. On the light entrance surface 110a, for example, the surface treatment layer 110b including a diffractive optical element in which frustoconical fine patterns are arrayed in the XY direction may be provided. By designing the fine shape pattern such that a large part of the diffracted light is diffracted in the substantially Z axis direction or in a diffraction angle range near the Z axis when light enters the inclined surface inclined by the angle ϕ′ with respect to the vertical axis in the XZ plane in the −X/+Z direction, a large part of the light S entering the light entrance surface 110a can be directed in the Z axis direction within the light entrance section 110 and guided to the light guiding section 120. Note that a number of at least one inclined surface of the light entrance surface 110a is not limited to three, and may include one, two, or four or more.

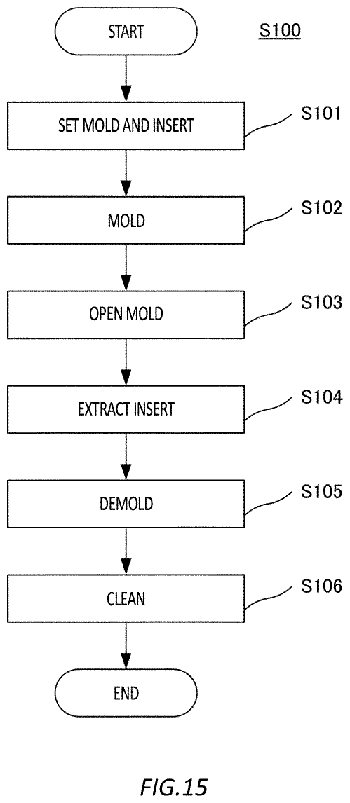

FIG. 15 illustrates a first manufacturing method flow S100 of the light guide 100. In the present embodiment, as an example, the acrylic resin is used as a molding material of the light guide 100. In other words, the light entrance section 110 and the light guiding section 120 are formed of a same material.

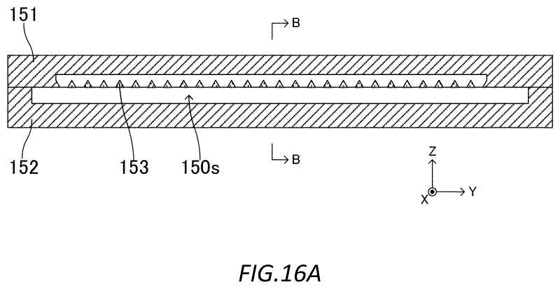

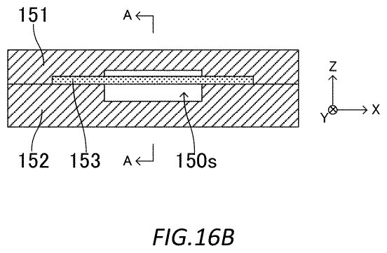

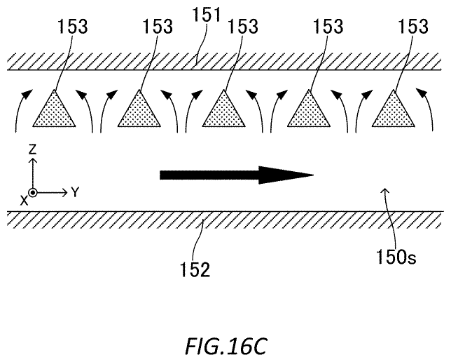

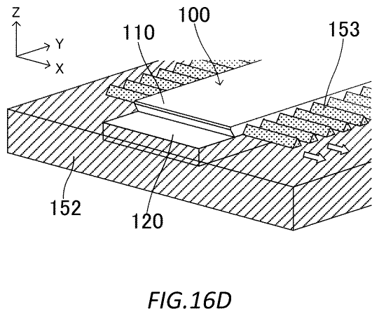

In Step S101, molds 151 and 152 and a plurality of inserts 153 are set. FIG. 16A and FIG. 16B illustrate an internal state of the molds 151 and 152 in a front view (along a reference line AA in FIG. 16B) and in a side view (along a reference line BB in FIG. 16A), respectively. The mold 151 is a metal mold for forming the light entrance section 110 and includes an internal space having a size and shape which can accommodate the light entrance section 110 and the plurality of inserts 153. The mold 152 is a metal mold for forming the light guiding section 120 and includes an internal space having a size and shape which can accommodate the light guiding section 120. The plurality of inserts 153 are metal molds for forming the space 130s in the light entrance section 110 (between a plurality of light collecting elements 111), and are solid columnar bodies having a substantially isosceles triangular cross-sectional shape.

The mold 152 is arranged with the internal space of the mold 152 being oriented in the +Z direction, the plurality of inserts 153 are arranged side by side in the Y axis direction on the mold 152 so as to extend across the internal space of the mold 152 in the X axis direction, and the mold 151 is laid on the mold 152 with the internal space of the mold 151 being oriented in the −Z direction. As a result, an internal space 150s, which is vertically divided by the plurality of inserts 153 except for some part, is formed between the molds 151 and 152.

In Step S102, the light guide 100 is molded by injecting the acrylic resin into the molds 151 and 152. FIG. 16C illustrates a flow of the resin within the molds 151 and 152. The resin is injected into a lower part of the internal space 150s via a through hole (not illustrated) of the mold 152 and is loaded into an upper part via a gap between the plurality of inserts 153 while being loaded in a direction of a black arrow. When the resin is cooled after a certain period of time, the process proceeds to a next step.

In Step S103, the mold is opened by pulling the mold 151 in the +Z direction. As a result, as illustrated in FIG. 16D, the light entrance section 110 is exposed on the mold 152 with the light guiding section 120 fitted into the internal space of the mold 152.

In Step S104, the plurality of inserts 153 are extracted. FIG. 16D illustrates a state where the plurality of inserts 153 are extracted from the light guide 100. The plurality of inserts 153 are extracted in a direction of a white arrow (+X direction). Note that, in order to facilitate extraction from the light guide 100, the plurality of inserts 153 may be formed in a tapered shape in which a +X end is thinner than a −X end.

In Step S105, the light guide 100 is removed from the mold 152. As a result, the light guide 100 illustrated in FIG. 1A is obtained.

In Step S106, the molds 151 and 152 and the plurality of inserts 153 are cleaned. Then, the flow ends. A plurality of light guides 100, each being the light guide 100, can be manufactured by repeating Steps S101 to S106.

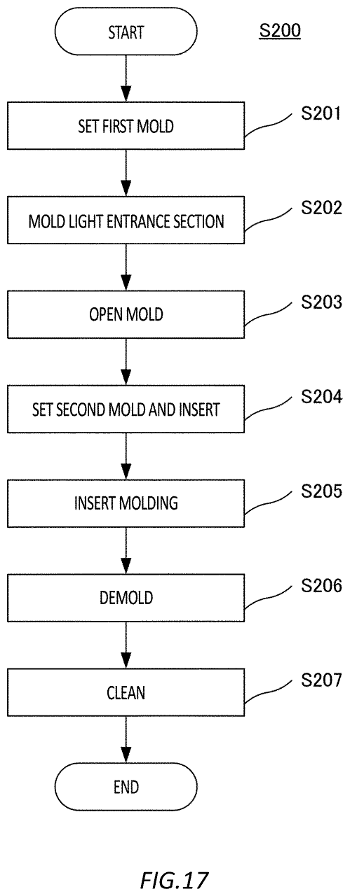

FIG. 17 illustrates a second manufacturing method flow S200 of the light guide 100. In the present embodiment, as an example, the acrylic resin is used as the molding material of the light guide 100. In other words, the light entrance section 110 and the light guiding section 120 are formed of the same material.

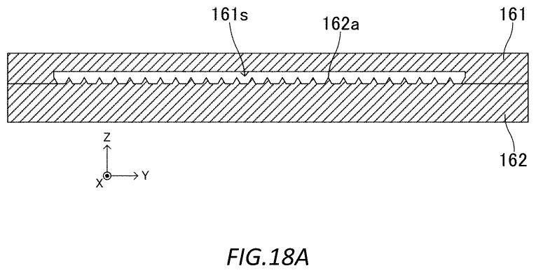

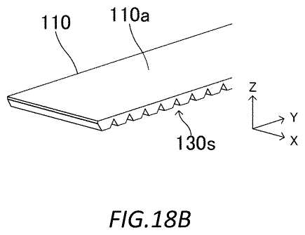

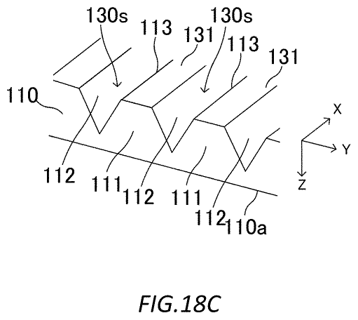

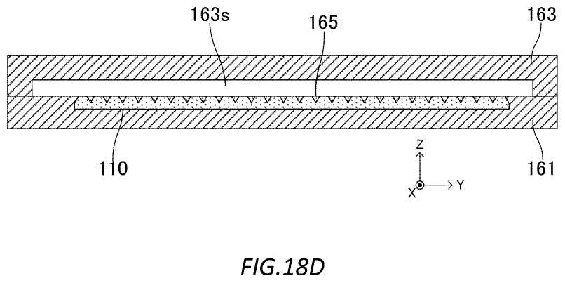

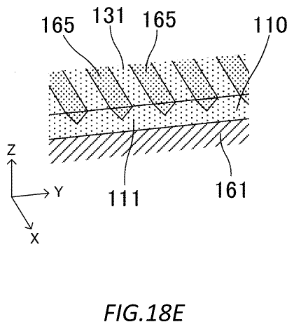

In Step S201, molds 161 and 162 are set. FIG. 18A illustrates an internal state of the molds 161 and 162 in a front view (when viewed in the X axis direction). The molds 161 and 162 are a pair of metal molds for forming the light entrance section 110. The mold 161 includes an internal space having a size and shape which can accommodate the light entrance section 110. The mold 162 has a plurality of protruding edges 162a which protrude from an upper surface in the +Z direction and which are arranged side by side in the Y axis direction. The plurality of protruding edges 162a are a structure for forming the space 130s in the light entrance section 110 (between a plurality of light collecting elements 111), and are formed to have a substantially isosceles triangular cross-sectional shape and extend in the X axis direction.

The mold 162 is arranged with the plurality of protruding edges 162a facing the +Z direction, and the mold 161 is laid on the mold 162 with the internal space of the mold 161 facing the −Z direction to accommodate the protruding edges 162a. As a result, an internal space 161s is formed between the molds 161 and 162.

In Step S202, the light entrance section 110 is molded by injecting the acrylic resin into the molds 161 and 162. FIG. 18B and FIG. 18C illustrate an overall configuration of the light entrance section 110 molded and a structure on the −Z side, respectively. The light entrance section 110 is integrally molded such that the plurality of light collecting elements 111 are arrayed in parallel in the Y axis direction as described above and the space 130s is included between the light collecting elements 111 adjacent to one another. The continuous section 131 is formed on a −Z surface of each of the light collecting elements 111. In other words, in the present example, the continuous section 131 is integrally molded with the light entrance section 110. A detailed configuration of the continuous section 131 is as described above.

In Step S203, the mold 161 is opened from the mold 162. In this state, the light entrance section 110 is accommodated in the mold 161.

In Step S204, the mold 161 and a mold 163, and a plurality of inserts 165 are set. FIG. 18D and FIG. 18E illustrate an internal state of the molds 161 and 163 in a front view (when viewed in the X axis direction), and in a perspective view, respectively. The mold 163 has a similar configuration to that of the mold 152 described above. The plurality of inserts 165 each have a similar configuration to that of each of the inserts 153 described above. However, a length thereof is equal to the width of the light entrance section 110 in the X axis direction.

The mold 161 in which the light entrance section 110 is accommodated is vertically inverted, the inserts 165 are respectively inserted into a plurality of spaces 130s, each being the space 130s, of the light entrance section 110, and the mold 163 is laid on the mold 161 with the internal space of the mold 163 facing the −Z direction. As a result, the light entrance section 110 in which the plurality of inserts 165 are respectively fitted into the spaces 130s is accommodated in the internal space of the mold 161, so that an internal space 163s is formed between the mold 161 and the mold 163.

In Step S205, the light guide 100 is molded by insert molding by injecting the acrylic resin into the molds 161 and 163. The resin is injected into the internal space 163s via a through hole (not illustrated) of the mold 163 and is loaded onto the +Z side of the light entrance section 110. When the resin is cooled after a certain period of time, the resin forms the light guiding section 120 and is integrated with the light entrance section 110 via the continuous section 131 (see FIG. 18C).

In Step S206, the light guide 100 is removed from the molds 161 and 163 and the plurality of inserts 165 are extracted from the light guide 100. Note that, in order to facilitate extraction from the light guide 100, the plurality of inserts 165 may be formed in a tapered shape in which a +X end is thinner than a −X end. As a result, the light guide 100 illustrated in FIG. 1A is obtained.

In Step S207, the molds 161, 162, and 163 and the plurality of inserts 165 are cleaned. Then, the flow ends. A plurality of light guides 100, each being the light guide 100 can be manufactured by repeating Steps S201 to S207.

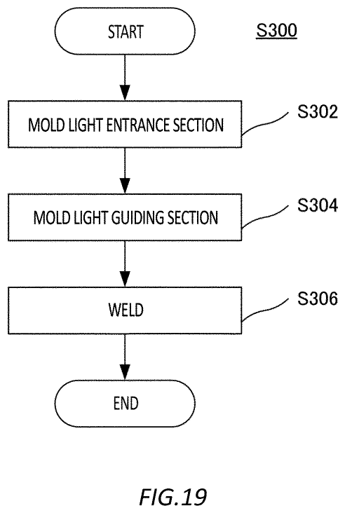

FIG. 19 illustrates a third manufacturing method flow S300 of the light guide 100. In the present embodiment, as an example, the acrylic resin is used as the molding material of the light guide 100. In other words, the light entrance section 110 and the light guiding section 120 are formed of the same material.

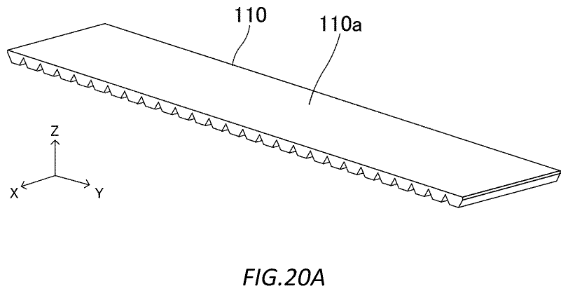

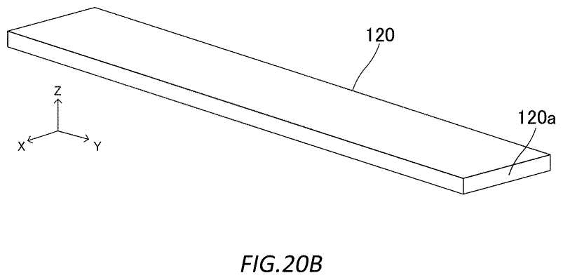

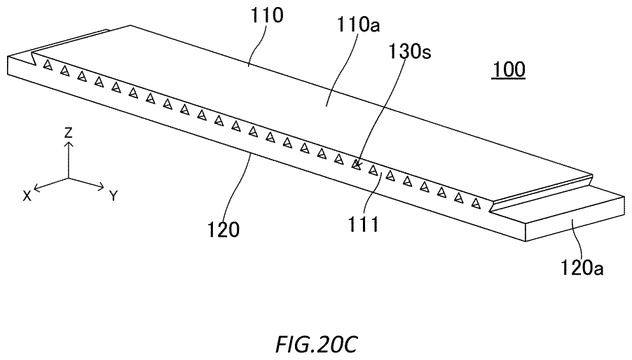

In Step S302, the light entrance section 110 is molded. The light entrance section 110 can be molded by Steps S201 to S203 described above. FIG. 20A illustrates a configuration of the light entrance section 110 molded. The light entrance section 110 is formed as a body separate from the light guiding section 120.

In Step S304, the light guiding section 120 is molded. A detail of molding will be omitted. FIG. 20B illustrates a configuration of the light guiding section 120 molded. The light guiding section 120 is formed as a body separate from the light entrance section 110.

In Step S306, the light guide 100 is formed by welding the light entrance section 110 and the light guiding section 120. As illustrated in FIG. 20C, the light entrance section 110 is arranged on the +Z end surface of the light guiding section 120 such that one end surface of the light entrance section 110 where the spaces 130s are formed faces the −Z side. As a result, a −Z surface of the light entrance section 110 abuts on the +Z end surface of the light guiding section 120. In this state, the light entrance section 110 and/or the light guiding section 120 are welded to one another by applying ultrasonic vibration to them. As a result, the light entrance section 110 and the light guiding section 120 are joined to one another via the continuous section 131 to form the light guide 100.

Note that before the ultrasonic vibration is applied to the light entrance section 110 and/or the light guiding section 120, for example, the welded part may be irradiated with infrared rays to be preheated, the light entrance section 110 and the light guiding section 120 may be brought into contact with one another, and the light entrance section 110 and the light guiding section 120 may be welded by generating frictional heat by applying vibration in a direction parallel to a contact surface while pressurizing in a contact direction. As a result, it is possible to perform welding without air entrapment and with suppressed bead formation.

Note that, not limited to welding, for example, the light entrance section 110 and the light guiding section 120 may be bonded by using a solvent. For example, a small gap may be provided between the light entrance section 110 and the light guiding section 120, a photocurable adhesive may be flowed into the gap by a capillary force, and light may be radiated to cure the photocurable adhesive, thereby joining the light entrance section 110 and the light guiding section 120. In addition, the light entrance section 110 and the light guiding section 120 may be joined by using an optical tape (for example, ACO04N manufactured by 3M). The light guide 100 may be molded using a 3D printer.

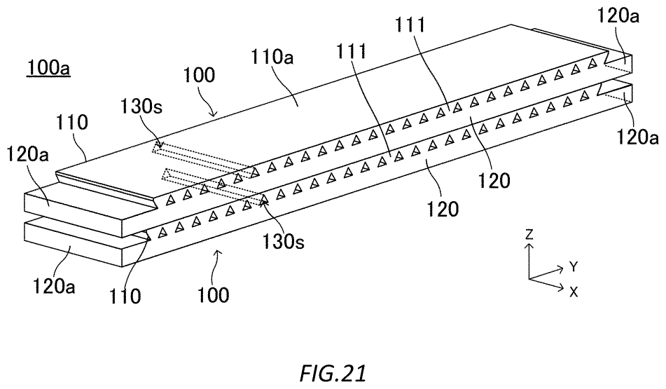

FIG. 21 illustrates a light guide assembly 100a according to the present embodiment. The light guide assembly 100a includes two light guides 100 stacked in the Z axis direction. Here, the light guide 100 at an upper stage is arranged on the light entrance surface 110a of the light guide 100 at a lower stage. A small gap is provided between the light entrance surface 110a of the light guide 100 at the lower stage and a −Z surface of the light guide 100 at the upper stage.

In each of the two light guides 100, the light entrance section 110 is formed to be rotationally symmetric by 180 degrees with respect to the Z axis direction. In the light guide 100 at the upper stage, the reflective surface 112 is positioned on a +Y end surface and the reflective surface 113 is positioned on a −Y end surface. The light guiding section 120 is also formed to be rotationally symmetric by 180 degrees with respect to the Z axis direction. Here, a difference between a distance L₁₁₂ from a +Y end of the light guiding section 120 to the reflective surface 112 of the light entrance section 110 closest to the +Y end and a distance L₁₁₃ from a −Y end of the light guiding section 120 to the light entrance section 110 closest to the −Y end is substantially equal to a width of the continuous section 131 and the non-continuous section 132 in the Y axis direction, or ½ of an array pitch P of the plurality of light collecting elements 111.

In this regard, in the light guide assembly 100a, the light guide 100 at the lower stage is arranged to be rotated by 180 degrees with respect to the Z axis compared to the light guide 100 at the upper stage. As a result, the reflective surface 113 is positioned on a +Y end surface of the light entrance section 110 and the reflective surface 112 is positioned on a −Y end surface. Then, the light guide 100 at the upper stage is arranged on the light entrance surface 110a of the light guide 100 at the lower stage and +Y end surfaces thereof are aligned. As a result, the light collecting elements 111 of the light guide 100 at the upper stage are arrayed to be offset from the light collecting elements 111 of the light guide 100 at the lower stage by P/2 in the Y axis direction, so that the reflective surfaces 112 and 113 of the plurality of light collecting elements 111 of the light guide 100 at the lower stage are each positioned below (in the −Z direction from) the light transmitting section 114 of the plurality of light collecting elements 111 of the light guide 100 at the upper stage.

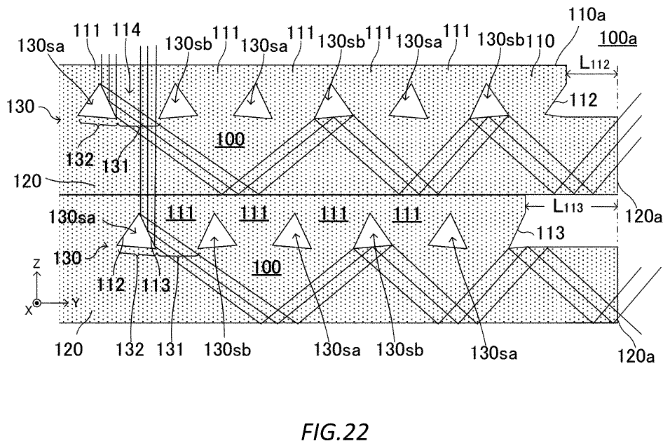

FIG. 22 illustrates a principle of collection of the light input to the light guide assembly 100a by the light entrance section 110 and guidance of the light by the light guiding section 120. Here, an optical path of the light entering the light guiding section 120 without being reflected by the reflective surfaces 112 and 113 of the light entrance section 110 of the light guide 100 at the upper stage via the light transmitting section 114 therebetween (the light transmitting section 114 of the light collecting element 111 on the left in the figure) is illustrated. Note that the guidance of the light which enters the reflective surfaces 112 and 113 of the light entrance section 110 is as described above using FIG. 2.

The light entering the light guiding section 120 via the light transmitting section 114 of the light entrance section 110 passes through the −Z end surface 120b of the light guiding section 120 and leaks to an outside of the light guide 100 at the upper stage and enter the light guide 100 at the lower stage from its light entrance surface 110a in the −Z direction. Here, by positioning the reflective surfaces 112 and 113 of the light guide 100 at the lower stage below the light transmitting section 114 of the light guide 100 at the upper stage, the light passing through the +Y side of the light transmitting section 114 at the upper stage is reflected by the reflective surface 113 on the +Y side at the lower stage, passes through the continuous section 131 while keeping collimated, and enters the light guiding section 120 at the lower stage. As described above using FIG. 2, the reflected light entering the light guiding section 120 is guided within the light guiding section 120 rightward so that the light is output from the light exit surface 120a, by being reflected by the −Z end surface 120b of the light guiding section 120 and the interface between the light guiding section 120 and the non-continuous section 132.

Note that the light (not illustrated) passing through the −Y side of the light transmitting section 114 at the upper stage is reflected by the reflective surface 112 on the −Y side at the lower stage, passes through the adjacent continuous section 131 while keeping collimated, and enters the light guiding section 120 at the lower stage. The reflected light entering the light guiding section 120 is guided within the light guiding section 120 leftward so that the light is output from another light exit surface 120a.

In this manner, a large part of the light entering the light guide assembly 100a can be confined within the light guiding section 120 so that the light is output from the light exit surface 120a, by the light guide 100 at the lower stage collecting the light exiting from the light entrance section 110 (light collecting elements 111) of the light guide 100 at the upper stage without being reflected by the reflective surfaces 112 and 113 via the light transmitting section 114 therebetween and the light guiding section 120 to the outside of the light guide 100, that is, leaked light.

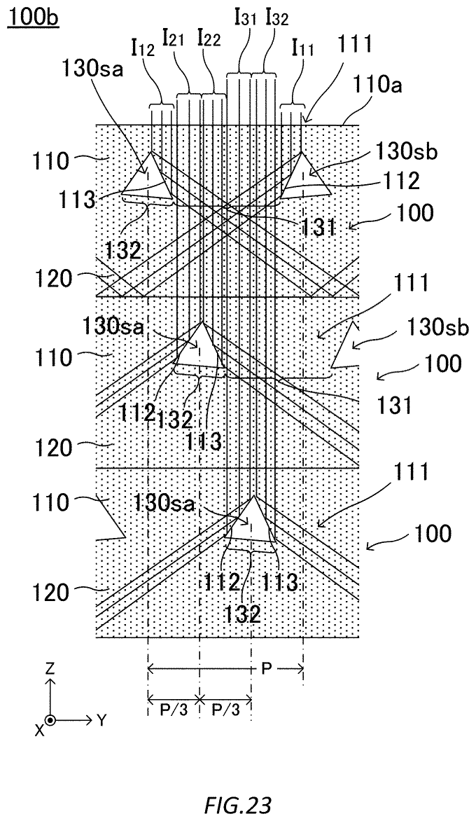

FIG. 23 illustrates a configuration and a light focus principle of a light guide assembly 100b according to a variant. The light guide assembly 100b includes three light guides 100 stacked in the Z axis direction. Here, the light guide 100 at a middle stage is arranged on the light entrance surface 110a of the light guide 100 at a lower stage and the light guide 100 at an upper stage is arranged on the light entrance surface 110a of the light guide 100 at the middle stage. A small gap is provided between the three light guides 100. In each of the light guides 100, the continuous section 131 has a width twice the non-continuous section 132 and the three light guides 100 are arrayed such that respective light collecting elements 111 are offset by P/3 in the Y axis direction. As a result, the reflective surfaces 112 and 113 of the light collecting elements 111 of the light guides 100 at the middle stage and the lower stage are positioned below (in the −Z direction from) the light transmitting section 114 of the light collecting elements 111 of the light guide 100 at the upper stage.

Light 111 and 112, as a part of the light which enters the light entrance surface 110a of the light guide 100 at an upper end, are guided within the light guiding section 120 at the upper stage so that the light is output from the light exit surface 120a, by being reflected by the reflective surfaces 112 and 113 of the light entrance section 110 at the upper stage, respectively. As a part of light passing through the light transmitting section 114 between the reflective surfaces 112 and 113 of the light guide 100 at the upper end, light 121 and 122 passing through the −Y side are guided within the light guiding section 120 at the middle stage by being reflected by the reflective surfaces 112 and 113 of the light entrance section 110 at the middle stage, respectively, and light 131 and 132 passing through the +Y side are guided within the light guiding section 120 at the lower stage by being reflected by the reflective surfaces 112 and 113 of the light entrance section 110 at the lower stage, respectively, so that the light is output from the light exit surface 120a of the respective light guide 100. In this manner, the light guide assembly may have a configuration in which widths of the reflective surfaces 112 and 113 of the light entrance section 110 and the continuous section 131 are changed (1 to n−1) and the light guides 100 are stacked in a plurality (N) of stages and arranged to be offset by P/N in the Y axis direction.

The light guide 100 according to the present embodiment is a light guide which guides light input from the light entrance surface 110a to the light exit surface 120a so that the light is output from the light exit surface 120a, and includes: the light entrance section 110 which has the light entrance surface 110a to which light is input in the −Z direction, and the reflective surfaces 112 and 113 and the light transmitting section 114 which are positioned in the −Z direction with respect to the light entrance surface 110a, the reflective surfaces 112 and 113 reflecting a part of the light input from the light entrance surface 110a, and the light transmitting section 114 transmitting another part of the light input from the light entrance surface 110a and reflected light reflected by the reflective surfaces 112 and 113; the light guiding section 120 which has the light exit surface 120a which is positioned on the −Z side with respect to the light entrance section 110, and guides the reflected light in the Y axis direction so that the reflected light is output from the light exit surface 120a; and the continuous section 131, which is provided such that the light transmitting section 114 and the light guiding section 120 are continuous, and the non-continuous section 132, which is provided such that the reflective surfaces 112 and 113 and the light guiding section 120 are spaced apart from one another, the continuous section 131 and the non-continuous section 132 each being arranged at a boundary between the light entrance section 110 and the light guiding section 120. According to the above, a large part of the light collected by the light entrance section 110 can be output from the light exit surface 120a, by a part of the light input to the light entrance section 110 in the −Z direction via the light entrance surface 110a being reflected by the reflective surfaces 112 and 113 of the light entrance section 110 and the reflected light entering the light guiding section 120 from the light transmitting section 114 of the light entrance section 110 via the continuous section 131 to be guided within the light guiding section 120 along the Y axis.

In addition, the light guide assembly 100a according to the present embodiment includes two light guides 100 stacked in the Z axis direction. According to the above, a large part of the light entering the light guide assembly 100a can be confined within the light guiding section 120 so that the light is output from the light exit surface 120a, by collecting, by the light guide 100 at the lower stage, the light exiting from the light entrance section 110 (light collecting elements 111) of the light guide 100 at the upper stage without being reflected by the reflective surfaces 112 and 113 via the light transmitting section 114 therebetween and the light guiding section 120 to the outside of the light guide 100, that is, leaked light.

Note that a bottom surface structure 121 may be provided on the bottom surface of the light guiding section 120 such that the light guided from the light entrance section 110 to the light guiding section 120 is guided for a long distance in the Y axis direction without leaking or with minimal leakage via the light entrance section 110.

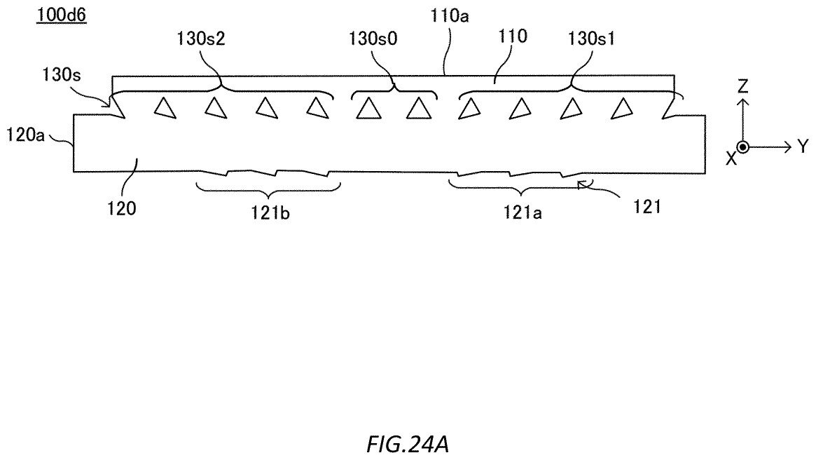

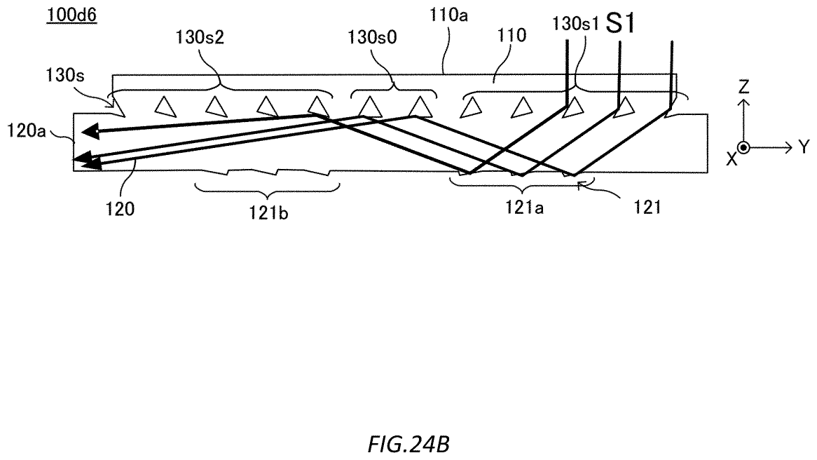

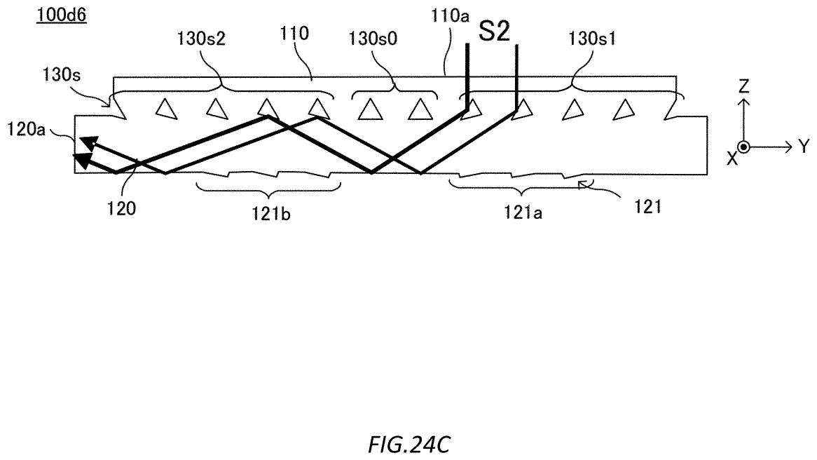

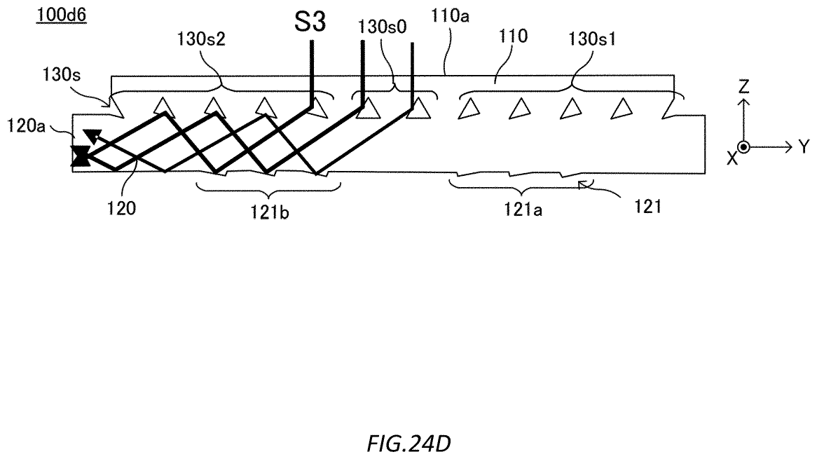

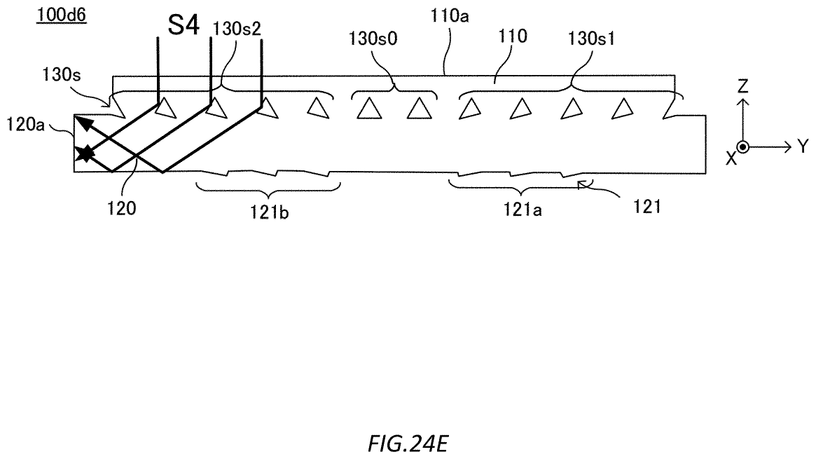

FIG. 24A illustrates a configuration of a light guide 100d6 according to a sixth variant having a bottom surface structure 121. The light guide 100d6 includes the light entrance section 110 and the light guiding section 120, and a plurality of spaces 130s are arrayed in the Y axis direction between the light entrance section 110 and the light guiding section 120. As an example, the plurality of spaces 130s includes two spaces 130s0 each having an equilateral triangular cross-section at a center in the Y axis direction, five spaces 130s1 each having a triangular cross-section extending in the −Y/−Z direction on the +Y side, and five spaces 130s2 each having a triangular cross-section extending in the +Y/−Z direction on the −Y side. The light guiding section 120 includes the bottom surface structure 121 protruding in the −Z direction and extending in the X axis direction on its bottom surface. The bottom surface structure 121 includes three bottom surface structures 121a having inclined surfaces facing the +Y/−Z direction on the +Y side of the light guiding section 120 and three bottom surface structures 121b having inclined surfaces facing the −Y/−Z direction on the −Y side of the light guiding section 120. Note that a number of at least one space 130s and a number of at least one bottom surface structure 121 may be arbitrarily determined.

FIGS. 24B to 24E illustrate guidance of light input to the light guide 100d6 according to the sixth variant. As illustrated in FIG. 24B, as a part of the light entering the light entrance section 110 from the light entrance surface 110a, light S1 reflected by left inclined surfaces (reflective surfaces 112) of three spaces 130s1 on the +Y side is guided to three bottom surface structures 121a and reflected by the inclined surfaces, then guided and reflected by the bottom surfaces of two spaces 130s0 and the bottom surface (non-continuous section 132) of the space 130s2 on the +Y side, and then output from the light exit surface 120a on the −Y side, respectively. As illustrated in FIG. 24C, light S2 reflected by left inclined surface (reflective surfaces 112) of the two spaces 130s1 on the −Y side is guided and reflected by a center of the bottom surface of the light guiding section 120, then guided and reflected by the bottom surfaces (non-continuous section 132) of the two spaces 130s2 on the +Y side, guided and reflected by the bottom surface on the −Y side of the light guiding section 120, and then output from the light exit surface 120a on the −Y side, respectively. As illustrated in FIG. 24D, light S3 reflected by left inclined surfaces (reflective surface 112) of two spaces 130s0 and the left inclined surface (reflective surface 112) of the space 130s2 on the +Y side is guided to three bottom surface structures 121b and reflected by the inclined surfaces, then guided to the bottom surfaces (non-continuous section 132) of three spaces 130s2 on the −Y side and reflected, and then output from the light exit surface 120a on the −Y side, respectively. As illustrated in FIG. 24E, light S4 reflected by left inclined surfaces (reflective surfaces 112) of three spaces 130s2 on the −Y side is guided and reflected by the bottom surface on the −Y side of the light guiding section 120, and then output from the light exit surface 120a on the −Y side, respectively. In this manner, the bottom surface structure 121 is provided in the light guiding section 120 to cause the light entering the light guiding section 120 from the light entrance section 110 to be oriented in the Y axis direction within the light guiding section 120 at a small angle with respect to the Y axis direction, so that the light can be guided to the light exit surface 120a with a small number of reflections. That is, the light guiding distance of light within the light guiding section 120 can be increased.

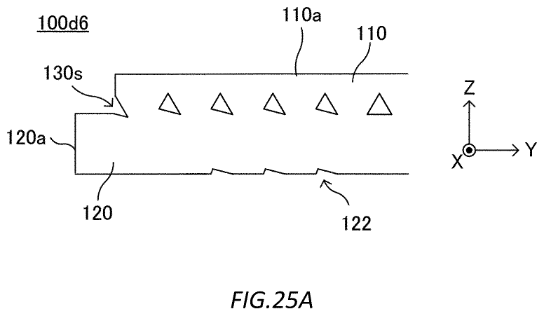

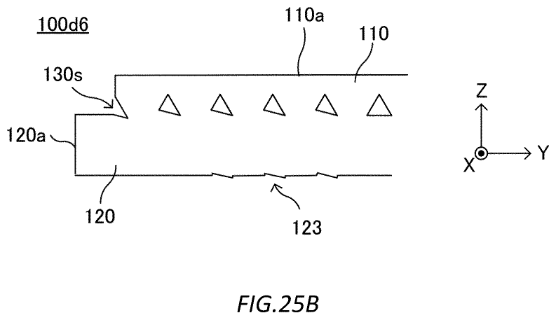

FIGS. 25A and 25B illustrate other examples of bottom surface structures 122 and 123. The bottom surface structure 122 illustrated in FIG. 25A is a groove-shaped structure formed on the bottom surface of the light guiding section 120 so as to be recessed in the +Z direction and extend in the X axis direction. The bottom surface structure 123 illustrated in FIG. 25B is an uneven structure formed on the bottom surface of the light guiding section 120 such that a half part protrudes in the −Z direction and a remaining half part is recessed in the +Z direction and extends in the X axis direction. The inclined surfaces of the bottom surface structures 122 and 123 are inclined at a same angle as the inclined surface of the bottom surface structure 121.

Note that the −Z end surface may be mirror-finished in order to increase the reflectance at the inclined surface of the bottom surface structures 121 to 123. In addition, a reflective film may be provided by using metal or the like.

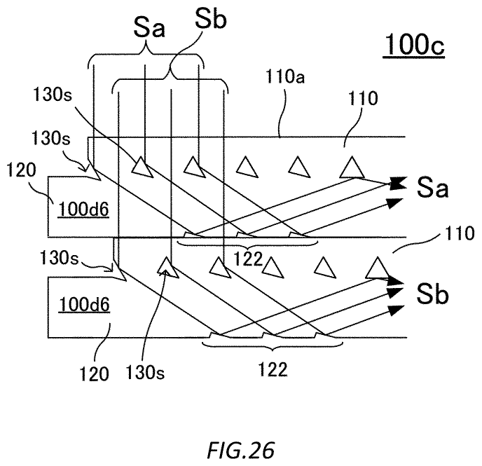

FIG. 26 illustrates a light guide assembly 100c formed by using the light guide 100d6 according to the sixth variant. The light guide assembly 100c includes two light guides 100d6 stacked in the Z axis direction. Here, the two light guides 100d6 each have the bottom surface structure 122. The light guide 100d6 at an upper stage is arranged on the light entrance surface 110a of the light guide 100d6 at a lower stage. The light collecting elements 111 of the light guide 100d6 at the upper stage are arrayed to be offset from the light collecting elements 111 of the light guide 100d6 at the lower stage by P/2 in the Y axis direction, so that the reflective surfaces 112 and 113 of the plurality of light collecting elements 111 of the light guide 100 at the lower stage are each positioned below (in the −Z direction from) the light transmitting sections 114 of the plurality of light collecting elements 111 of the light guide 100 at the upper stage. As a result, the light Sa reflected by the reflective surfaces 112 and 113 of the light guide 100d6 at the upper stage is guided to the light guiding section 120 at the upper stage and guided in the Y axis direction, and the light Sb entering the light guiding section 120 via the light transmitting section 114 of the light guide 100d6 at the upper stage passes through the −Z end surface 120b of the light guiding section 120 and leaks to an outside of the light guide 100 at the upper stage, enters the light guide 100d6 at the lower stage from its light entrance surface 110a in the −Z direction, is reflected by the reflective surfaces 112 and 113 of the light guide 100d6 at the lower stage, and is guided to the light guiding section 120 at the lower stage and guided in the Y axis direction. As a result, a large part of the light entering the light guide assembly 100c can be confined within the two light guiding sections 120 and output from the two light exit surfaces 120a.

Note that the upper surface (the light entrance surface 110a of the light entrance section 110) and the lower surface (the −Z surface of the light guiding section 120) of the light guide 100 according to the present embodiment may be smooth surfaces. As a result, it is possible to prevent deposition of dust or the like when the light guide 100 is placed outdoors.

Note that in the light guide 100 according to the present embodiment, the light guiding section 120 is formed in a plate-like shape so as to extend in the Y axis direction orthogonal to the light input direction (Z axis direction), but, it is not limited to this, and the light guiding section 120 may be formed to be curved in any direction intersecting the input direction, for example, curved in an arc shape, a spherical shell shape, or the like. In addition, the light guiding section 120 may be formed to extend to be curved or bent from a portion overlapping with the light entrance section 110 in any direction or may be formed to extend to the light exit surface 120a with an increasing width or a decreasing width, or an increasing thickness or a decreasing thickness. As a result, the light collected by the light entrance section 110 is, after being guided into the light guiding section 120, guided toward the light exit surface 120a in any direction while being reflected by an end surface of the light guiding section 120.

Note that the light output from the light exit surface 120a of the light guide 100 may be input to another light guide (such as an optic fiber) which is different from the light guide 100 so that the light is output (emitted) at another end of the another light guide. For example, when a second light guide 100, which is separate from the light guide 100, is brought into contact with the light guide 100, and the light output from the light guide 100 is input to the second light guide 100 without exiting into air, a contact surface of the light guide 100 in contact with the second light guide 100 may be regarded as the light exit surface 120a. In addition, even when the light guide 100 is joined with the second light guide 100, which is separate from the light guide 100, by welding or the like so that the contact surface between the two light guides 100 does not exist, a boundary section (that is, the contact surface before welding) between the two light guides 100 may be regarded as the light exit surface 120a. Further, in the second light guide 100, a surface from which the light input from the light guide 100 is output may be regarded as the light exit surface 120a.

While the present invention has been described by way of the embodiments, the technical scope of the present invention is not limited to the above-described embodiments. It is apparent to persons skilled in the art that various alterations or improvements can be made to the above described embodiments. It is also apparent from description of the claims that the embodiments to which such changes or improvements are made may be included in the technical scope of the present invention.

It should be noted that each process of the operations, procedures, steps, stages, and the like performed by the device, system, program, and method shown in the claims, specification, or drawings can be executed in any order as long as the order is not indicated by “prior to”, “before”, or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

98: plane (north-south plane); 99: plane (movement trajectory plane); 100: light guide; 100a, 100b, 100c: light guide assembly; 100d1 to 100d6: light guide; 110: light entrance section; 110a: light entrance surface; 110b: surface treatment layer; 111: light collecting element; 112, 113: reflective surface; 114: light transmitting section; 120, 120d1: light guiding section; 120a: light exit surface; 120b: −Z end surface; 121, 121a, 121b, 122, 122, 123: bottom surface structure; 130: boundary section; 130s, 130s0, 130s1, 130s2, 130sa, 130sb: hollow space (space); 131: continuous section; 131a: first-width continuous section; 131b: second-width continuous section; 132: non-continuous section; 132a, 132b: non-continuous section; 132c: left non-continuous section; 132f: left non-continuous section; 150s: internal space; 151, 152: mold; 153: insert; 161, 162, 163: mold; 161s, 163s: internal space; 162a: protruding edge; 165: insert; Bb: rear-lower inclined surface angle; Bf: front-lower inclined surface angle; and S, S1, S2, S3, S4, SA, Sa, Sb, Sc, Sf: light.

What is claimed is:

1. A light guide which guides light input from a light entrance surface to a light exit surface which is different from the light entrance surface and outputs the light, the light guide comprising:
a light entrance section which has the light entrance surface provided such that the light is input from a first direction;
a light guiding section which is arranged on a side of the light exit surface with respect to the light entrance section and guides the light in a second direction intersecting the first direction; and
a continuous section which is provided such that the light entrance section and the light guiding section are continuous, and a non-continuous section which is provided such that the light entrance section and the light guiding section are spaced apart from one another, the continuous section and the non-continuous section each being arranged at a boundary between the light entrance section and the light guiding section, wherein
the light entrance section has a reflective surface which is provided so as to reflect a part of the light input from the light entrance surface, and a light transmitting section which transmits another part of the light input from the light entrance surface and reflected light reflected by the reflective surface,
the light guiding section is provided to further guide the reflected light in the second direction,
the continuous section is provided such that the light transmitting section of the light entrance section and the light guiding section are continuous, and
the non-continuous section is provided such that the reflective surface of the light entrance section and the light guiding section are spaced apart from one another.

2. The light guide according to claim 1, wherein an end of the non-continuous section on a side of the light guiding section is provided so as to extend obliquely with respect to the second direction.

3. The light guide according to claim 1, wherein the reflective surface includes a first reflective surface and a second reflective surface which are respectively positioned on one side and another side of the light transmitting section with respect to the second direction and are opposed to one another.

4. The light guide according to claim 3, wherein
the non-continuous section includes a first non-continuous section in which the first reflective surface and the light guiding section are spaced apart from one another and a second non-continuous section in which the second reflective surface and the light guiding section are spaced apart from one another, and
a first end of the first non-continuous section on a side of the light guiding section and a second end of the second non-continuous section on the side of the light guiding section are provided so as to extend obliquely in orientations different from one another with respect to the second direction.

5. The light guide according to claim 1, wherein the reflective surface includes a third reflective surface and a fourth reflective surface which are respectively positioned on one side and another side of the non-continuous section with respect to the second direction and face away from one another.

6. The light guide according to claim 5, wherein the third reflective surface and the fourth reflective surface are inclined in different orientations with respect to the second direction.

7. The light guide according to claim 1, wherein the continuous section and the non-continuous section adjacent to the continuous section have widths different from one another with respect to the second direction.

8. The light guide according to claim 1, wherein the continuous section and the non-continuous section adjacent to the continuous section have widths substantially equal to one another in the second direction.

9. The light guide according to claim 1, wherein an interface between the non-continuous section and the light guiding section at the boundary forms another reflective surface, and reflects the reflected light input from the light transmitting section to the light guiding section via the continuous section and guides the reflected light to the light exit surface.

10. The light guide according to claim 1, wherein
a plurality of reflective surfaces, each being the reflective surface, and a plurality of light transmitting sections, each being the light transmitting section, are arranged within the light entrance section along the second direction, and
a plurality of continuous sections, each being the continuous section, and a plurality of non-continuous sections, each being the non-continuous section, are arranged along the second direction at the boundary between the light entrance section and the light guiding section.

11. The light guide according to claim 10, wherein the plurality of non-continuous sections have substantially equal widths with respect to the second direction.

12. The light guide according to claim 10, wherein
the plurality of continuous sections include a first-width continuous section having a width of a first length in the second direction and a second-width continuous section having a width of a second length different from the first length in the second direction, and
the first-width continuous section and the second-width continuous section are alternately arranged.

13. The light guide according to claim 1, wherein the light entrance section is formed to extend in the second direction, and the light entrance surface is formed in a planar shape having a width in a third direction intersecting with each of the first direction and the second direction.

14. The light guide according to claim 13, wherein the light guiding section is formed to extend in the second direction.

15. The light guide according to claim 13, wherein an end of the light guiding section on a side opposite to the light entrance section in the first direction is formed in a planar shape.

16. The light guide according to claim 13, wherein the continuous section is formed to extend in the third direction.

17. The light guide according to claim 16, wherein the continuous section is arranged such that the third direction is substantially parallel to a plane including a movement trajectory of the Sun.

18. The light guide according to claim 16, wherein the light guiding section is arranged such that the second direction is substantially perpendicular to a plane including a movement trajectory of the Sun.

19. The light guide according to claim 16, wherein
the light entrance surface includes a surface treatment layer on which a diffractive optical element is disposed or which is formed such that a refractive index continuously changes in the first direction, and
an intersection line between a plane including a movement trajectory of the Sun and the light entrance surface is arranged to be inclined with respect to a horizontal direction.

20. The light guide according to claim 1, wherein the light entrance section and the light guiding section are each formed as a separate body and are formed by being joined to one another via the continuous section.

21. The light guide according to claim 20, wherein the light entrance section and the light guiding section are joined by welding.

22. The light guide according to claim 1, wherein the light entrance section and the light guiding section are formed of a same material.

23. A light guide assembly comprising two light guides stacked in the first direction, each being the light guide according to claim 1.

24. The light guide assembly according to claim 23, wherein a reflective surface of a light guide at a lower stage of the two light guides is positioned below a light transmitting section of a light guide at an upper stage of the two light guides.
